(19) United States
(12) Patent Application Publication
(10) Pub. No.: US 2019/0304313 A1
(43) Pub. Date: Oct. 3, 2019

(54) ESTIMATING AIRCRAFT OPERATIONS AT AIRPORTS USING TRANSPONDER DATA

(71) Applicant: Purdue Research Foundation, West Lafayette, IN (US)

(72) Inventors: John H. Mott, West Lafayette, IN (US); Darcy M. Bullock, Lafayette, IN (US); Margaret Leigh McNamara, West Lafayette, IN (US)

(21) Appl. No.: 16/366,547

(22) Filed: Mar. 27, 2019

Related U.S. Application Data
(63) Continuation of application No. 15/248,581, filed on Aug. 26, 2016, now abandoned.
(60) Provisional application No. 62/209,918, filed on Aug. 26, 2015.

(51) Int. Cl. G08G 5/00; G01S 19/03; G01S 13/76; H04W 84/06; H04B 7/185

(52) U.S. Cl. CPC G08G 5/0043; G08G 5/0026; G01S 19/03; G01S 13/765; G08G 5/025; G08G 5/0082; H04B 7/18506; G08G 5/0013; H04W 84/06

(57) ABSTRACT

A thorough understanding of aircraft operations counts at airports is helpful due to the use of those counts in the planning and design process and in the allocation of funds for improvement. Methods of counting aircraft operations at airports lacking full-time personnel are typically based on conventional statistical sampling using relatively small sample sizes due to the inherent difficulty and expense of positioning acoustic or pneumatic counting devices at those airports for extended periods of time. Such methods are often inaccurate because of the lack of sufficient representative samples. A means of counting operations using a combination of Mode C, Mode S, and ADS-B extended squitter aircraft transponder data received using a 1090 MHz software-defined radio system is disclosed herein. The increasing presence of such signals in both controlled and uncontrolled airspace around airports, due to a recent federal mandate that all aircraft in certain types of controlled airspace be equipped with ADS-B Out capability by 2020, lends itself to the measurement of operational parameters associated with the related aircraft. The 1090 MHz signals are received passively; i.e., there is no interrogation from the field-deployed device. The resulting sample counts are typically larger than those determined through conventional data collection procedures. In one aspect, these sample counts are applied to a Bayesian statistical estimation technique, which produces an improved estimate of operations.

### CROSS REFERENCE TO RELATED APPLICATION

This application is a continuation of U.S. patent application Ser. No. 15/248,581, filed Aug. 26, 2016, which claims the benefit of priority to U.S. Provisional Patent Application Ser. No. 62/209,918, filed Aug. 26, 2015, incorporated herein by reference.

### FIELD OF THE INVENTION

Various embodiments of the inventions disclosed herein pertain to air traffic management, and in particular to a method and system for accurately determining counts of aircraft operations at airports.

### BACKGROUND OF THE INVENTION

This section introduces aspects that may help facilitate a better understanding of the disclosure. Accordingly, these statements are to be read in this light and are not to be understood as admissions about what is or is not prior art.

Accurate measurement of aircraft operations at airports is essential for several reasons. First, an understanding of airport capacities and related constraints, essential due to their relation to the tactical planning of takeoff and landing operations and the mitigation of congestion-induced delays, should necessarily include a comprehensive knowledge of the magnitude and nature of operations at the associated airport. Second, the overall master planning process at an airport, which includes planning for AIP grant funding related to projects designed to improve airport capacities, inherently includes a concomitant understanding of the level of aircraft operations. In addition, effective airport system planning and coordination of environmental studies is dependent on a thorough comprehension of aircraft operational metrics.

Aircraft operations measurement at airports with full-time operating control towers is a relatively straightforward procedure; those operations are recorded by tower personnel, transmitted to the Federal Aviation Administration, and made available in the FAA's Air Traffic Activity System (ATADS) database. That database contains traffic information gathered from a number of different air traffic control facilities, including airport control towers, terminal radar approach control facilities (TRACONs), and air route traffic control centers (ARTCCs). The data is filterable by date, airport, state, region, service area (an FAA-defined facilities grouping), and class of related airspace.

Operations counts at airports that are not equipped with a full-time control tower are much more difficult to establish. Several different methods of establishing such counts have been used with limited degrees of success. These methods can be grouped into visual and mechanical methods, the delineation between them being that visual methods include an observer to be physically present to make and record the counts. The mechanical methods typically rely on either acoustic or pneumatic tube counters; such methods of counting can be relatively accurate, but are not viable perdurable solutions due to the expense and inconvenience of deploying the devices on a large scale and lack of their long-term reliability as a result of aging and environmental conditions.

Because of the difficulties inherent in the direct measurement of operations at airports without full-time control towers, airport planners generally employ estimation techniques to provide approximate values for operations counts. Estimation methods tend to fall into four categories: recollections of individuals, ratios of operations to based aircraft, measurements over a brief period and extrapolation thereof, and statistical estimation. The first of these methods, based on individual recollection, is problematic due to inaccuracies in both observation and recall of information. The second is unreliable due to wide variations in such ratios across particular airports. The third lacks reliability both due to seasonal and cyclical variation, and because it normally combines data from towered airports, which has been determined to be a poor predictor of non-towered airport operations.

Current means of statistical estimation of aircraft operations at airports, while likely the most useful of the operations count estimation techniques, themselves potentially suffer from insufficient accuracy related to sample size limitations. These deficiencies, along with an explanation of how the invention improves their accuracy, are discussed herein.

Ford and Shirack suggest an estimation procedure based on conventional sampling theory using stratified sampling in which the total number of annual operations is approximated by the sum of estimates within stratified samples, which are themselves based on sample means within those strata. In addition, the procedure employs a confidence interval based on the t-statistic for the sample variances corrected for finite population.

There are several aspects associated with this approach. First, conventional sampling theory and the use of the t-distribution for small sample sizes assume that means of the samples from the overall population are normally distributed with standard deviation/\sqrt{n}. While this assumption is justified for a normal population, it does not hold otherwise, and, while “Student's” probability integral gives better results in certain non-normal populations than does the Gaussian integral, it fails with enough frequency to warrant further research in this area. In particular, the uniform distribution is more applicable to the estimation problem at hand, and therefore suggests application of a more appropriate estimation technique. Second, stratified sampling methods use homogeneous subgroups, which can be problematic without a thorough understanding of the operations at a particular airport. These methods can also be difficult to implement as a result of the need to sample operations at different times and under different conditions, which leads to additional expense.

There is therefore an unmet for methods and systems that address such shortcomings.

### SUMMARY OF THE INVENTION

In one aspect, the purpose of the methods and system disclosed herein is to use aircraft transponder data to determine when an aircraft operation has occurred.

Another aspect of the present invention pertains to a method for counting unique aircraft operations. Some embodiments include using aircraft transponder data to estimate aircraft operations at airports using statistical techniques.

Yet another aspect of the present invention pertains to a method for analyzing transponder data for outputting aircraft operations data. Some embodiments include analyzing transponder data logged by a field device and providing an output.

For the purpose of demonstration of the principles disclosed herein, one embodiment uses transponder data transmitted on 1090 MHz in one of three formats: Mode C, Mode S, or Mode S Extended Squitter, to determine the position of the aircraft transmitting the data relative to the airport runway, and determine when an aircraft operation has occurred. However, this invention is sufficiently general such that other frequencies and data formats can be used.

In another embodiment, the herein disclosed system includes three components. The first component records the time stamp of raw transponder data. The second component comprises an algorithm to process that transponder data into meaningful information with associated time stamps. The third component is a separate algorithm that tabulates summary statistics characterizing airport operations and employs statistical techniques to handle the related data uncertainty.

In another aspect, the time stamp of raw transponder data is recorded and the transponder data samples are used as an input to a Bayesian estimator to predict the total number of aircraft operations over the period. The invention comprises a computer, a radio programmed to receive aircraft transponder signals, the associated antenna, a means of logging the data collected and transmitting it to a server using a WiFi communications link, the estimation software, and a power supply. The computer, SDR, antenna, and power supply will be enclosed in a portable, weatherproof case suitable for field deployment. Power can be supplied by one of three means: conventional alternating current, a battery, or a battery augmented with solar collectors.

One aspect of the present invention pertains to a system for counting unique aircraft operations. Some embodiments include a field data collection device, configured to collect and log a plurality of transponder data. Yet other embodiments include a server, wherein the server is communicatively coupled to the field data collection device and is configured to process the plurality of transponder data from the field collection device. Still further embodiments include a power source, wherein the power source is coupled to the field data collection device.

Various embodiments describe an algorithm for predicting airport operations counts using an electronic measuring and data collection device. A portion of actual operations goes unobserved by the device, and that a portion of the observed counts has an associated degree of uncertainty regarding inclusion in the sample. The algorithm was programmed using Bayesian Markov Chain Monte Carlo simulation software, and results compared against validated counts determined by direct observation. The prediction algorithm described herein produced substantially improved results over both conventional estimates and estimates adjusted using a minimum-variance unbiased estimation technique, achieving results that were within 10% of the actual total in the presence of considerable uncertainties in registered counts.

At least two modifications to the estimation procedure are suggested here. The first employs a Frequentist model based on sampling without replacement from a discrete, finite, uniformly-distributed population. The second involves a Monte Carlo simulation and associated Bayesian hierarchical model using a Poisson likelihood function, which incorporates the inherent Poisson nature of the underlying arrival process and assumes uncertainties in the registration of operations counts. The latter approach is shown to improve substantially the accuracy of both the traditional, unmodified predictor and the Frequentist modification.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, some of the figures shown herein may have been created from scaled drawings or from photographs that are scalable. It is understood that such dimensions, or the relative scaling within a figure, are by way of example, and not to be construed as limiting.

FIG. 1-1 illustrates the relationship of air traffic radar, ADS-B ground stations, and signal links.

FIGS. 1-2A-1-2C illustrate observing Mode C aircraft at low altitudes and long distances: (A) Mode C arriving aircraft transitioning from visible to invisible; (B) Mode C aircraft on runway and below radar coverage; and (C) Mode C departing aircraft transitioning from invisible to visible.

FIGS. 1-3A-1-3C illustrate Mode S aircraft visible at low altitudes and long distances: (A) Mode S arriving aircraft visible down to surface; (B) Mode S aircraft on runway and below radar coverage but visible to ADS-B receiver; and (C) Mode S departing aircraft remains visible on climb out/

FIG. 1-4 illustrates the distribution of general aviation transponder capabilities in the national airspace system.

FIG. 1-5A shows a block diagram of an algorithm according to one embodiment of the present invention.

FIG. 1-5B shows a transponder data receiver and collection unit according to one embodiment of the present invention.

FIG. 1-7 is a block diagram overview of the process according to one embodiment of the present invention used to determine operations counts.

FIG. 1-8 illustrates a Cirrus trainer departing and climbing out on downwind leg, KLAF (Lafayette, Ind.).

FIG. 1-9 is a graphical representation of the relative signal strength vs. time, N580PU, May 15, 2015, KLAF.

FIG. 1-10 is a photograph of an actual aircraft position overlaid on Google Earth, N580PU, May 15, 2015, KLAF.

FIG. 1-11 shows the basic Kalman filtering process.

FIG. 1-12 illustrates the incorporation of barometric altitude with signal strength to determine aircraft distance according to one embodiment of the present invention.

FIG. 2-4 shows a Bayesian Hierarchical Model.

FIGS. 2-6A, 2-6B, AND 2-6C are graphical representations of the posterior parameter and data distributions.

FIGS. 2-7A, 2-7B, 2-7C, and 2-7D show observed arrival rate estimation details.

FIGS. 2-8A, 2-8B, 2-8C, and 2-8D show total operations estimation details,

FIGS. 3-2A and 3-2B: LAF installation: (A) location of permanent installation and (B) polar plot of positions received (l=location of device).

FIGS. 3-3A and 3-3B: IND installation: (A) location of permanent installation and (B) polar plot of positions received (l=location of device).

FIGS. 3-4A, 3-4B, and 3-4C: Purdue Cirrus fleet use, Apr. 19 to Jun. 30, 2015: (A) dispatch hours, (B) aircraft used, and (C) hours of low visibility (<3 mi) at LAF by hour of day.

FIGS. 3-5A, 3-5B, and 3-5C: Fleet use details for Cirrus aircraft, Apr. 27 to May 3, 2015: (A) dispatch hours, (B) aircraft used, and (c) IFR flight time.

FIGS. 3-6A, 3-6B, and 3-6C: Cirrus aircraft, Apr. 27 to May 3, 2015: (A) dispatch turns, (B) time (h) during turns, and (c) touch and go by tail number.

FIGS. 3-7A and 3-7B: Airport operations case study (ADS-B capable aircraft, LAF): (A) by runway, Apr. 27 through May 3, 2015: and (B) by hour of day, Apr. 27 through May 1, 2015 (weekdays).

FIG. 3-8: IND operations, Jun. 25 to Jul. 1, 2015, by runway.

FIGS. 3-9A and 3-9B: ADS-B penetration in runway operations at three airports: (A) takeoffs and (B) landings.

FIG. 4-1 shows a runway bounding cuboid according to one embodiment of the present invention.

FIG. 4-2 is a general counting and estimation process flow diagram according to one embodiment of the present invention.

FIG. 4-3 is a field device decision logic flow diagram according to one embodiment of the present invention.

FIG. 4-4 is a server process flow diagram according to one embodiment of the present invention.

FIG. 4-5 illustrates the line-of-sight distance determination according to one embodiment of the present invention.

FIG. 4-6 is a graphical representation of the approximation of a typical DPSD using a fourth-order transfer function according to one embodiment of the present invention.

FIG. 4-7 is a graphical representation of the absolute error (km) distribution.

FIG. 5-1 illustrates an example of uncorrected convergence of sample maximum to population size.

FIG. 5-2 illustrates an example of convergence of sample maximum to population size using the minimum-variance unbiased estimator.

FIG. 5-3 illustrates mean-squared error of the estimators as a function of sample size.

FIG. 5-8 shows a photograph of a field device according to one embodiment of the present invention enclosed in a weatherproof case.

FIG. 5-9 shows a field device installation in a roadside cabinet.

FIG. 5-10 shows a view of the roadside cabinet installation in relation to the roadway.

FIG. 6-2 is a graphical representation of the distribution relative transponder signal strength as a function of aircraft distance from receiver; box widths are proportional to the square root of the number of observations in category.

FIGS. 6-3A, 6-3B, and 6-3C show two aircraft inbound to KLAF: (A) flightpaths, (B) aircraft altitudes vs. time, and (C) received transponder signal strength data (red=N589PU, blue=N580PU) vs. time.

FIG. 6-4 shows the estimation of unique Mode C aircraft engaged in an operation according to one embodiment of the present invention.

FIG. 6-5 is a photograph showing deployment of solar-powered data collection device at KCFJ according to one embodiment of the present invention.

FIG. 6-7 shows Bayesian posterior pmf for operations count estimate according to one embodiment of the present invention.

FIG. 6-8 is a graphical representation of quantile-quantile plot to determine normality of the data vector.

FIG. 6-9 is show the results of a discretized two-sample Komogorov-Smirnov test for the equality of distributions.

FIG. 6-10 is a graphical representation of the empirical cumulative distribution functions for operations counts.

### DETAILED DESCRIPTION OF ONE OR MORE EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention, and further permits the reasonable and logical inference of still other embodiments as would be understood by persons of ordinary skill in the art.

It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments, it therefore being understood that use of the word “preferably” implies the term “optional.”

Although various specific quantities (spatial dimensions, statistical parameters, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

What will be shown and described herein, along with various embodiments of the present invention, is discussion of one or more tests or simulations that were performed. It is understood that such examples are by way of example only, and are not to be construed as being limitations on any embodiment of the present invention. Further, it is understood that embodiments of the present invention are not necessarily limited to or described by the mathematical analysis presented herein.

Various references may be made to one or more processes, algorithms, operational methods, or logic, accompanied by a diagram showing such organized in a particular sequence. It is understood that the order of such a sequence is by example only, and is not intended to be limiting on any embodiment of the invention.

What will be shown and described herein are one or more functional relationships among variables. Specific nomenclature for the variables may be provided, although some relationships may include variables that will be recognized by persons of ordinary skill in the art for their meaning. For example, “t” could be representative of temperature or time, as would be readily apparent by their usage. However, it is further recognized that such functional relationships can be expressed in a variety of equivalents using standard techniques of mathematical analysis (for instance, the relationship F=ma is equivalent to the relationship F/a=m). Further, in those embodiments in which functional relationships are implemented in an algorithm or computer software, it is understood that an algorithm-implemented variable can correspond to a variable shown herein, with this correspondence including a scaling factor, control system gain, noise filter, or the like.

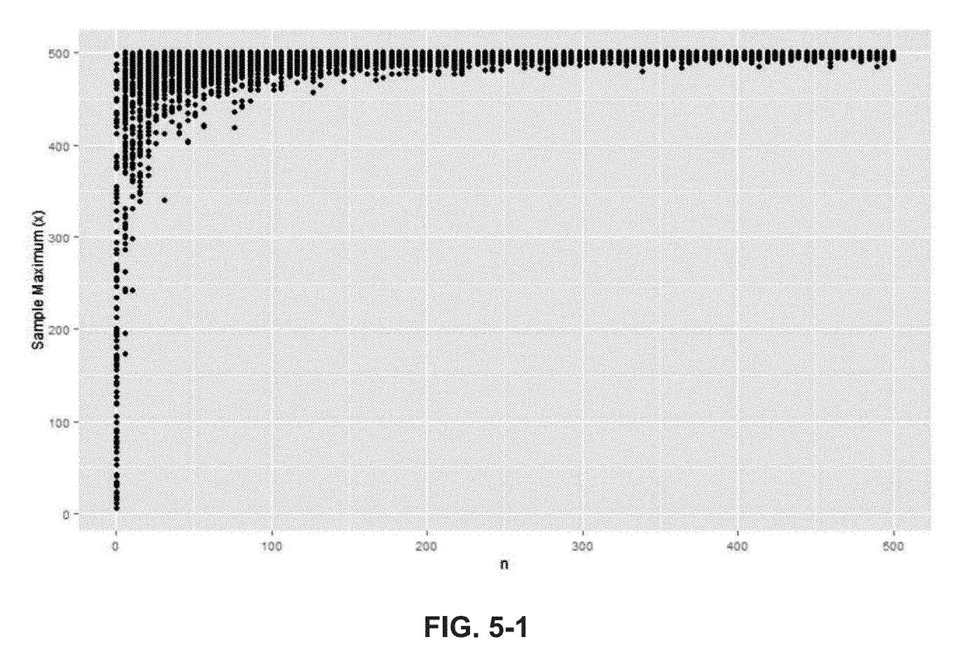

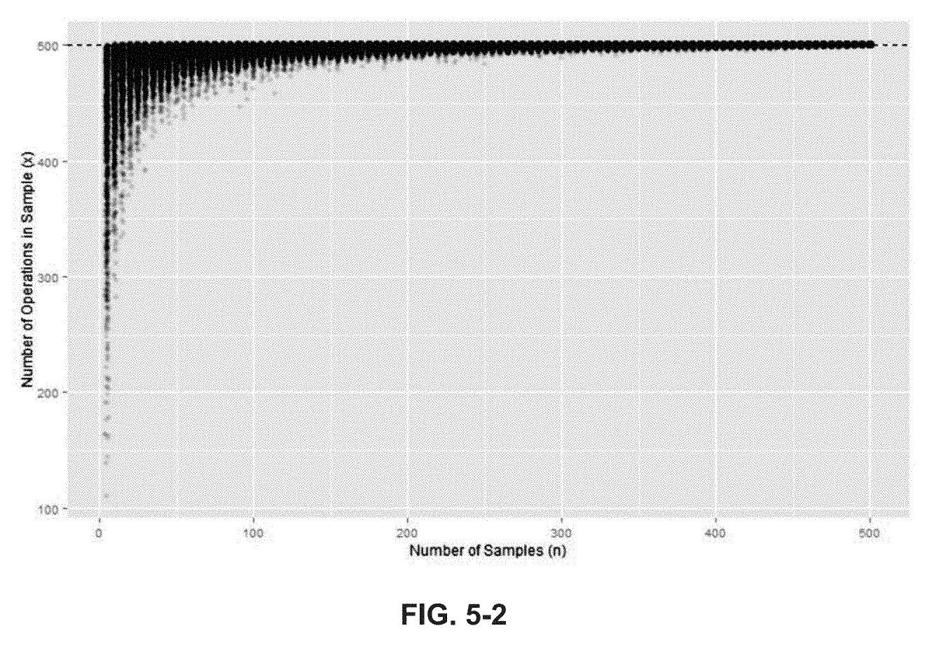

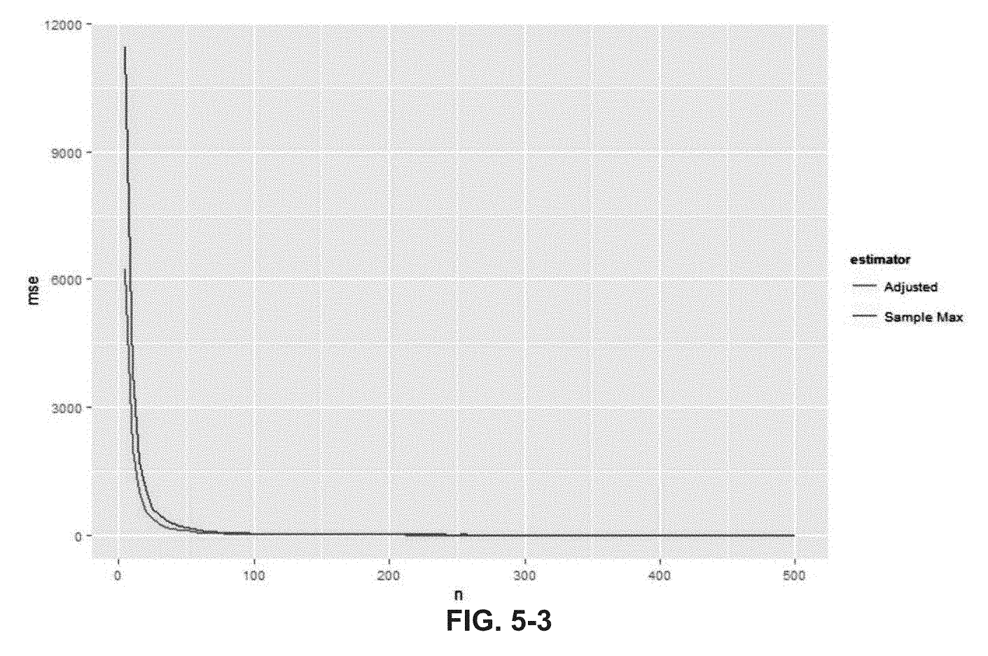

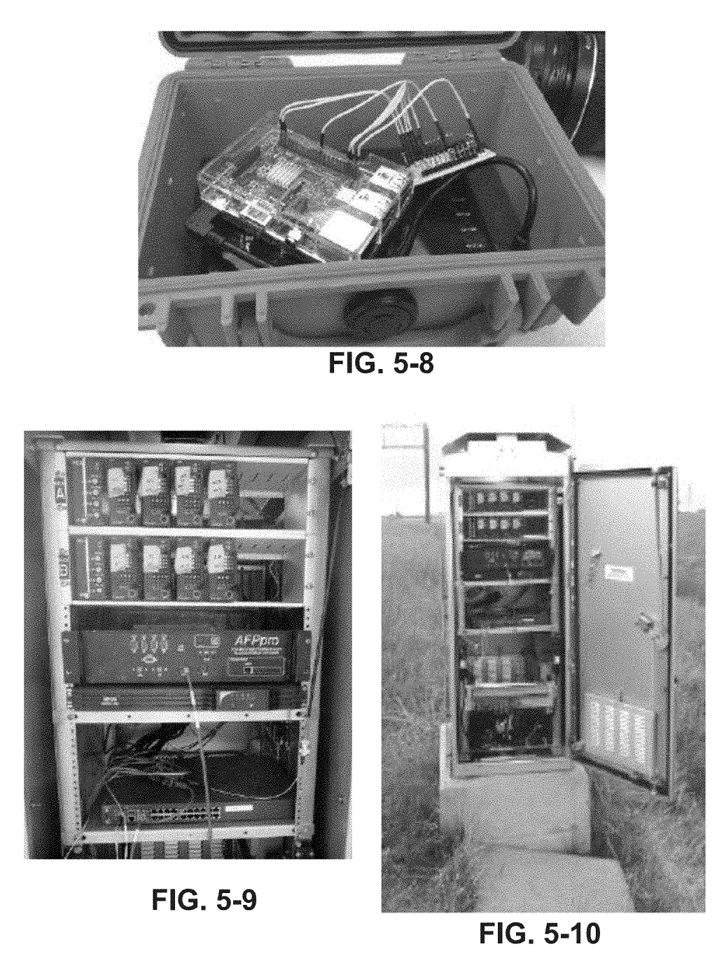

Although FAA has focused its NextGen initiatives on navigation, safety, and airspace management, the collateral benefits of transponder data for fleet utilization and counting aircraft operations have received little attention. Various embodiments of the present invention disclose a low-cost 1,090-MHz data collection device, Mode S and extended Mode S data can be captured to track airport operations and monitor fleet usage. Approximately 1.1 million records collected over a 3-month period were used to demonstrate the following:
Airport operations can be counted with Mode S data, which is significant because this approach is more cost-effective then current best practices outlined in ACRP Report 129.
The unique ICAO identifier in Mode S transmissions is useful for implementing low-cost real-time fleet tracking that may be of use to flight instruction schools that are want to improve efficiency.
Mode S extended squitter messages provide the ability to monitor the squat switch (air or ground), heading, and latitude and longitude. This information can be used to assign operations (landings, takeoffs, or touch-and-go) to particular runways. This capability was demonstrated at both LAF and IND, which has parallel runways.
The data collection infrastructure is portable and can be mounted in a small case for short-term battery-powered deployments (roughly 1 day per charge with a 22,400-mAh power source). FIG. 5-8 is a photograph of this 7-×5-×2.5-in. case. With a larger marine battery, the system can collect data for 7 to 14 days, depending on the size of the marine battery.
From the three installations, more than 25% of the aircraft operations were observed to have ADS-B capability. With the January 2020 deadline for ADS-B implementation, it is anticipated that ADS-B penetration will dramatically increase as the deadline is approached.

Various embodiments of the present invention pertain to a method of applying ADS-B data to fleet management and airport operations. With a 1,090-MHz receiver and appropriate signal processing hardware and software, Mode S and Mode S extended data can be used to track runway operations and fleet usage accurately and cost-effectively. Approximately 1.1 million records collected from sites adjacent to the Purdue University Airport, Indianapolis (Indiana) International Airport, and Paris Charles de Gaulle International Airport are used to provide several examples of airport operations and fleet utilization reports.

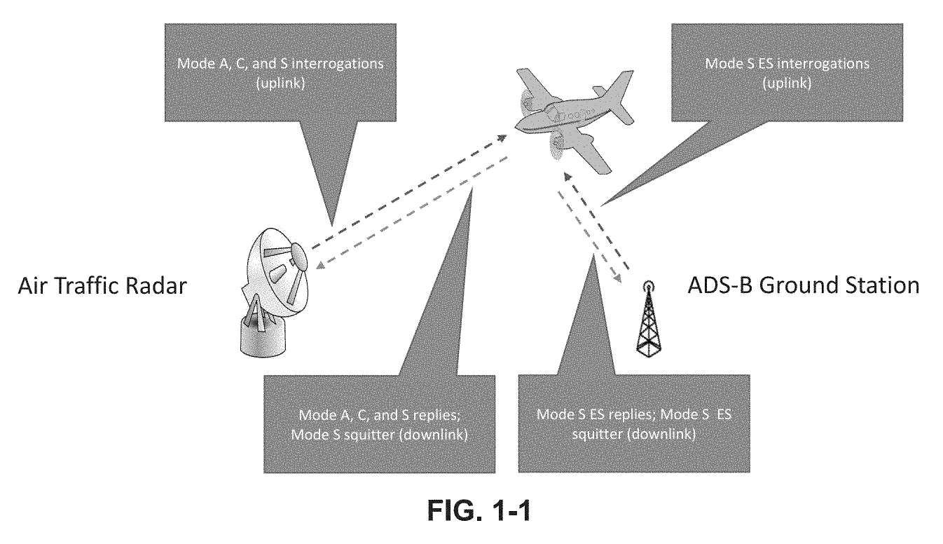

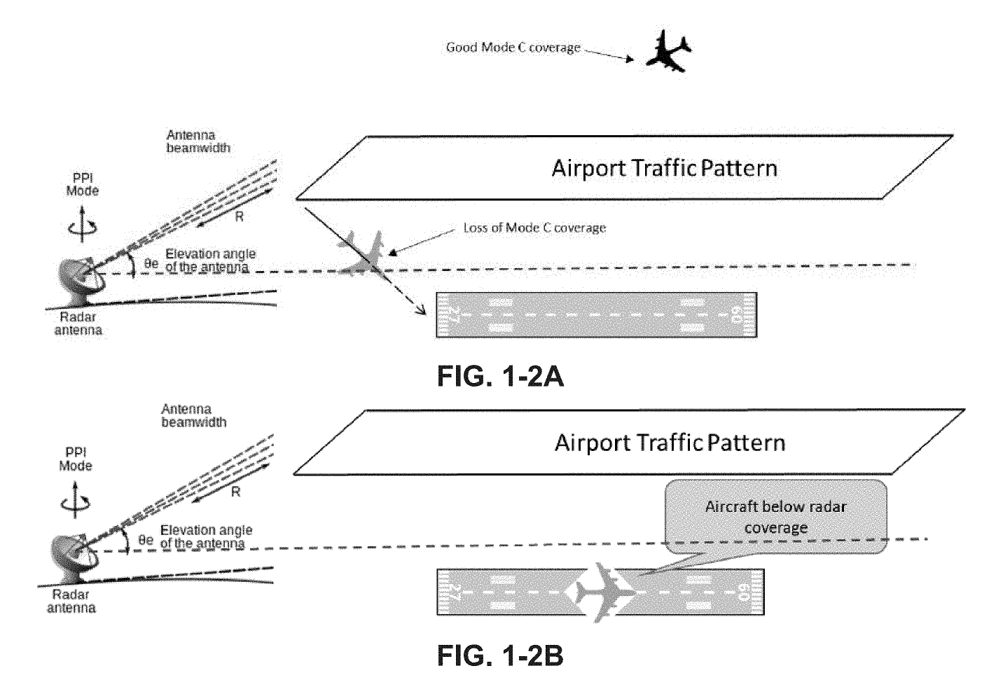

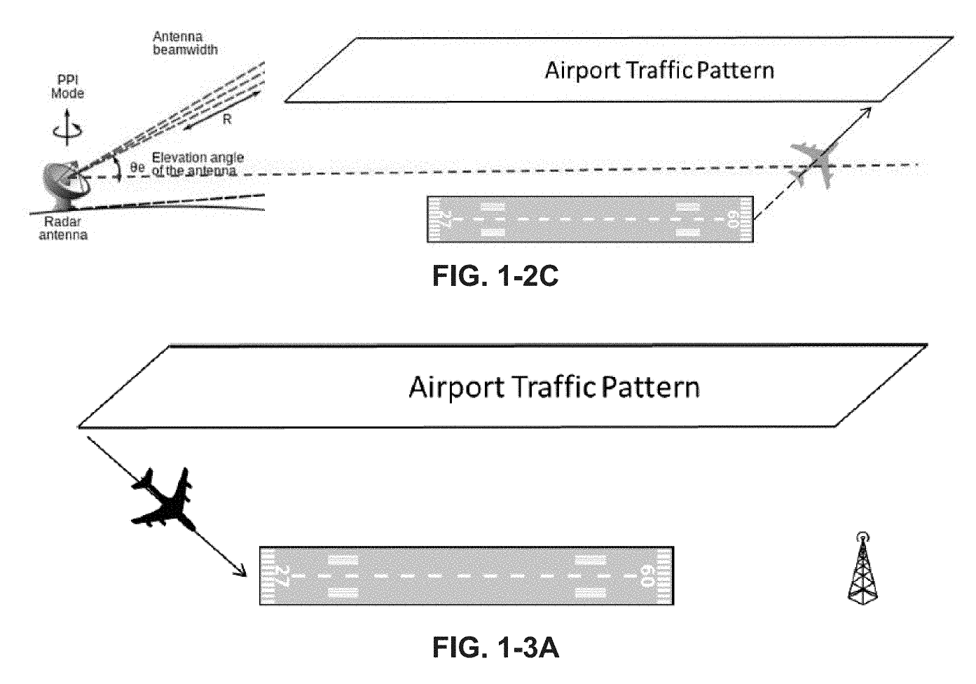

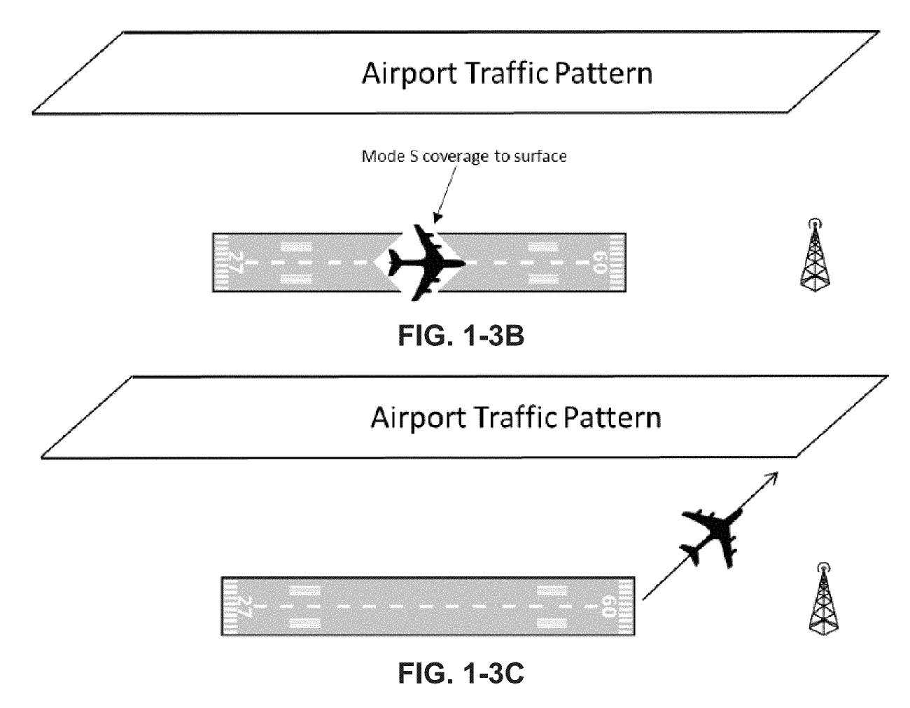

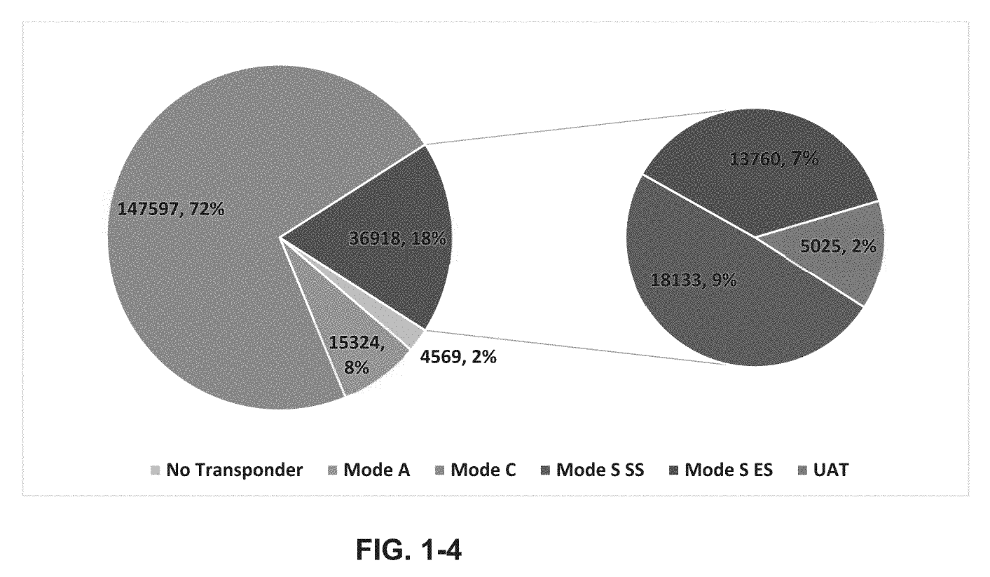

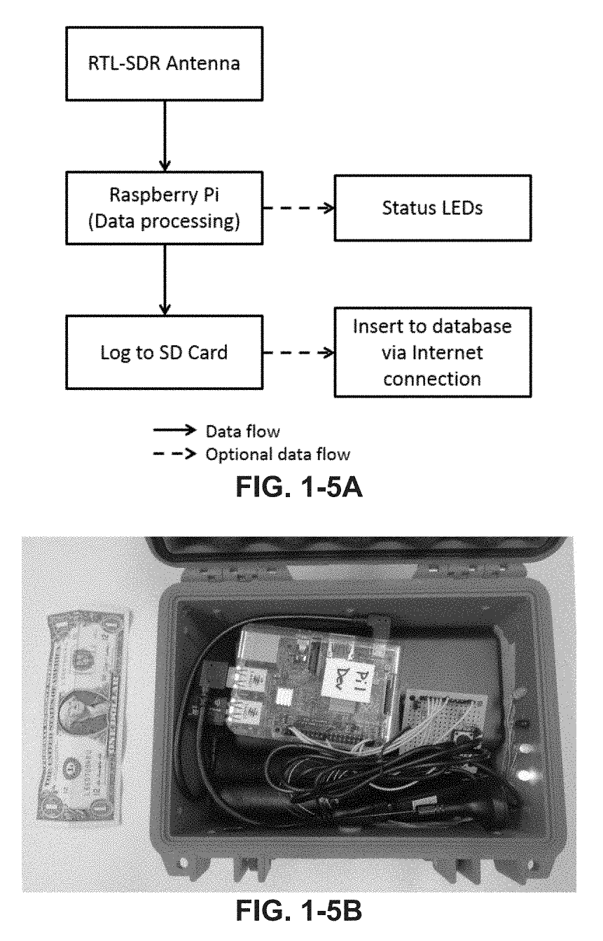

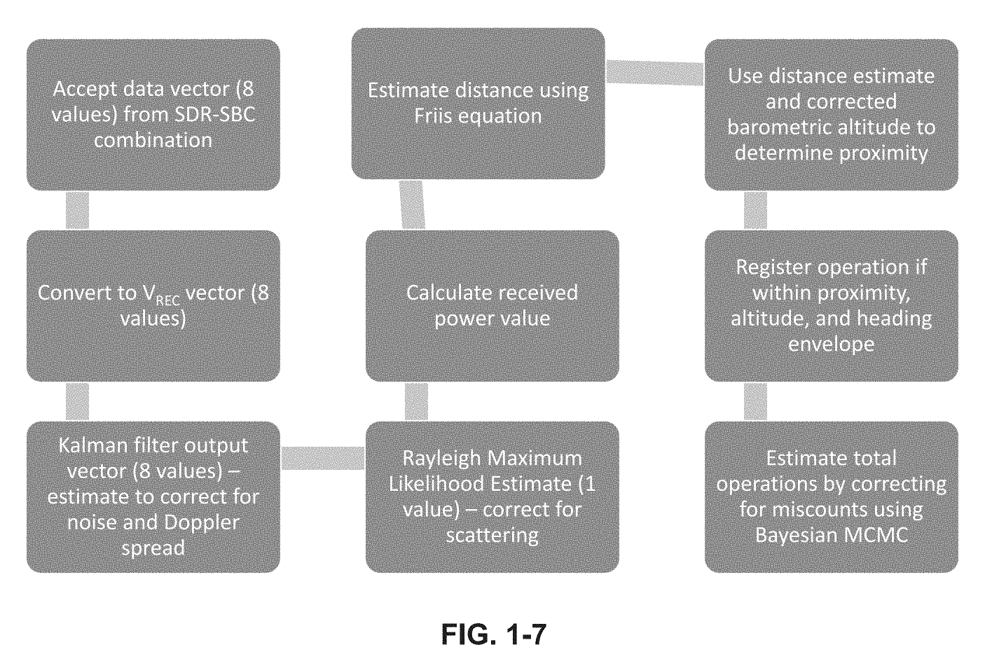

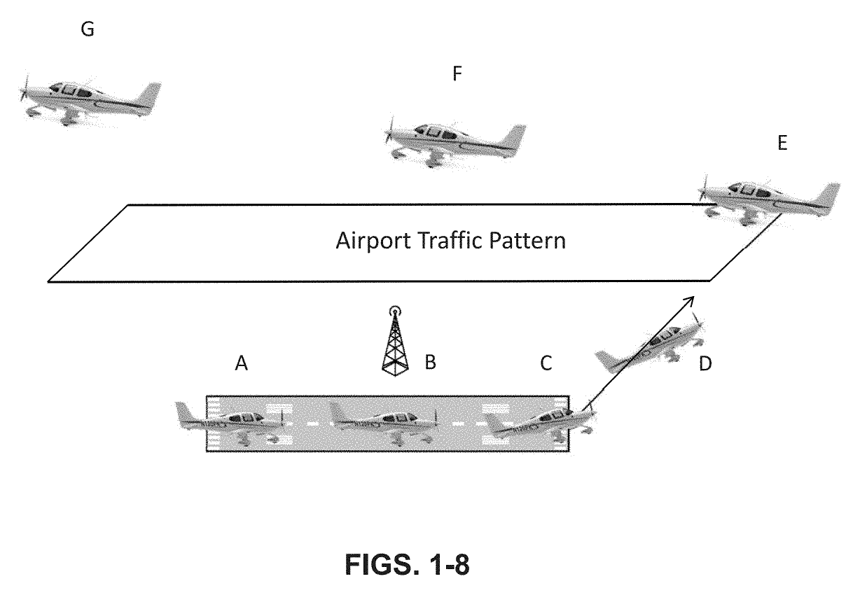

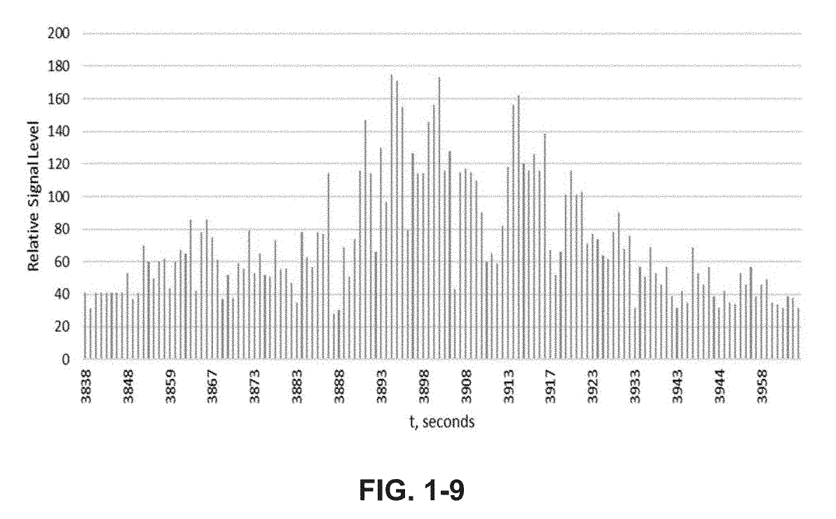

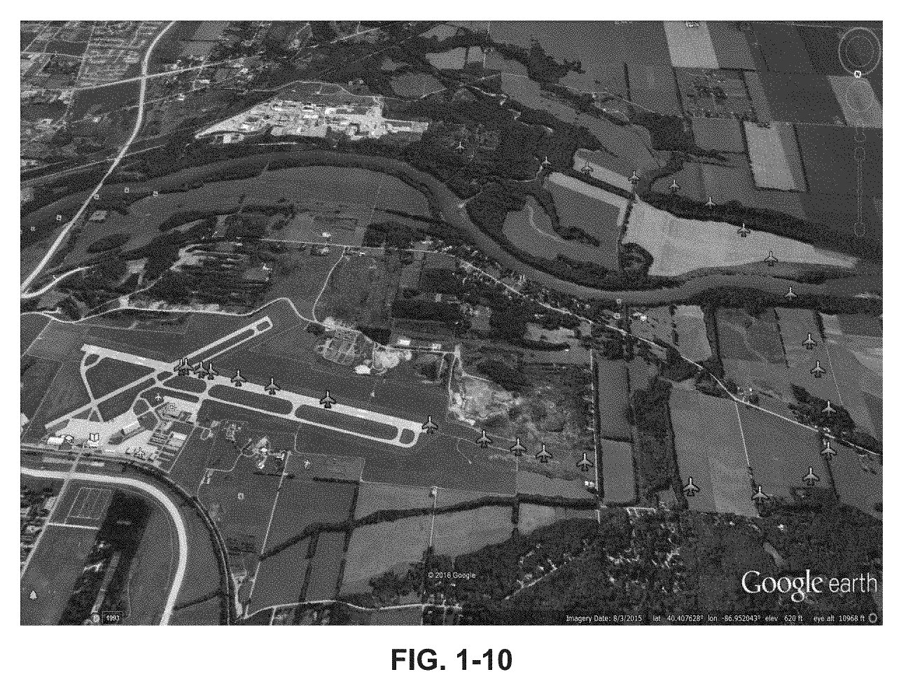

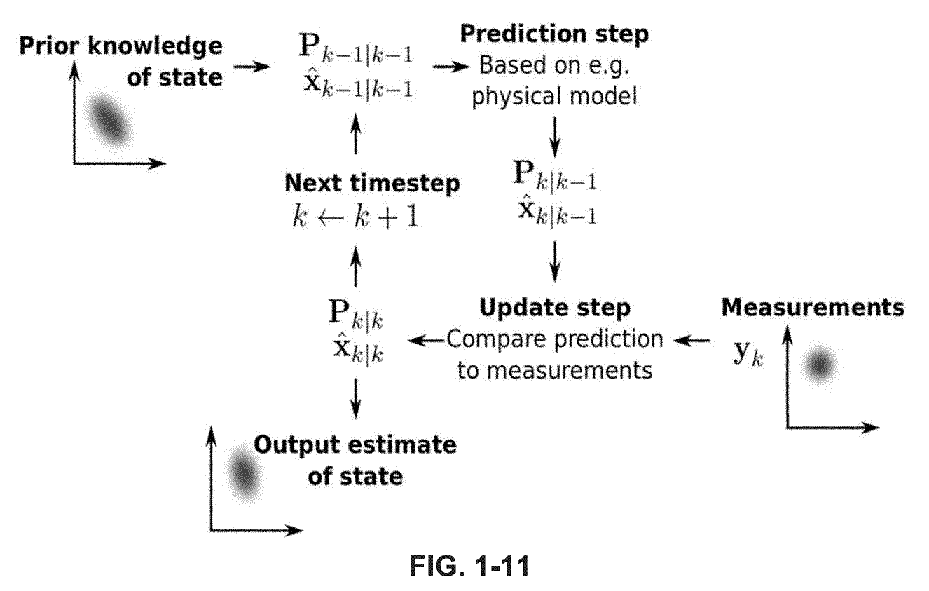

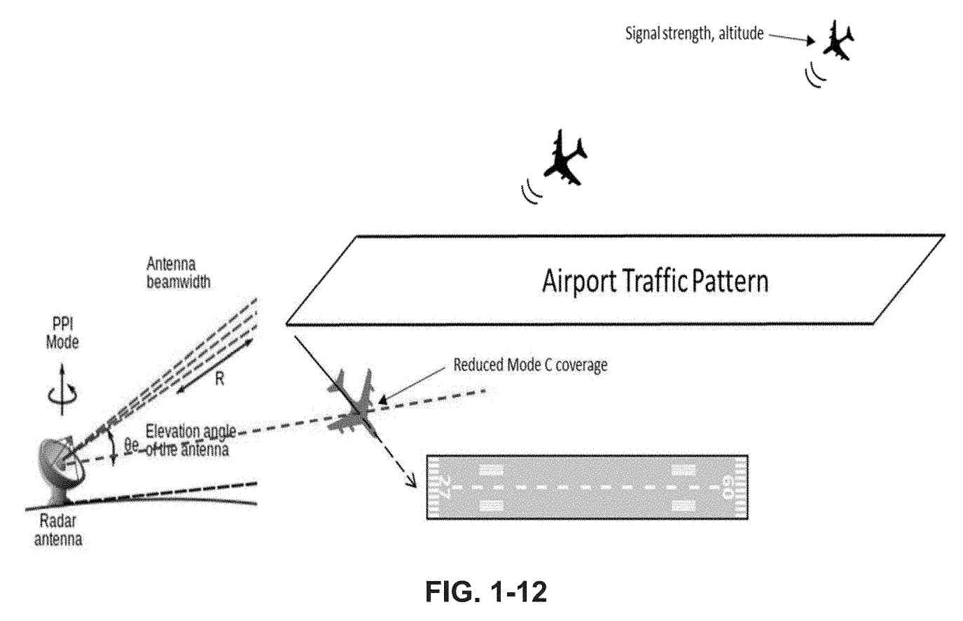

The device used to collect data consists of a small, feature-light computer (Raspberry Pi) that runs Linux and a USB software-defined radio with a vertically polarized, half-wave dipole antenna (FIG. 1-5B). This hardware either can be permanently installed with a wall socket and Ethernet cable or can be portable with a battery pack and no Internet connection. The structure of the device and a picture of the portable field deployment are shown in FIG. 1-5B. The data are collected by the antenna, processed on the Raspberry Pi, and stored on the SD card. Optionally, LEDs may be used to show the status of the computer when it is not connected to a monitor, and an Internet connection allows for data upload to a database. The software running on the Raspberry Pi was adapted from the open source software Dump1090, a tool for receiving and decoding messages from the antenna, to provide the SD card logging, LED indications, and SQL interface shown in FIG. 1-5A. Permanent, Internet-connected installations also make use of software provided by FlightAware, which wraps Dump1090 to communicate with its servers for logging and web display.

Using inexpensive, off-the-shelf hardware and modified open-source software, various embodiments of the present invention show that it is possible to construct a portable device that can be used to collect aircraft transponder signals and analyze the extracted data in such a manner that information related to the proximity and operational status of the associated aircraft can be determined. This process has significant implications with respect to the collection of metrics related to general aviation aircraft and to aircraft fleets operated by collegiate aviation programs, among others. Such a device could, for example, be used to determine the efficiency with which the aircraft in a particular fleet are being operated, and, if fleet efficiency improvements were implemented, serve as a means to validate the effects of the improvements. The device could also be used to assess the frequency of aircraft transiting a particular volume of airspace or landing or departing a particular airport. With access to a network connection, such data could be conveyed to a server for ease of analysis on a real-time basis.

A low-cost transponder data collection device according to one embodiment can be utilized to determine aircraft operations counts with an accuracy of greater than ±15% of actual operations by estimating craft proximity using signal strength and altitude information in conjunction with a self-tuning Kalman filter incorporating channel-optimized parameters based on known position data from Mode S ES transponders.

While primary radar is still an important part of the control of aircraft within the national airspace system, secondary surveillance, which relies on replies to interrogations from transponder-equipped aircraft and on squitter (non-interrogated) transmissions from automatic dependent surveillance—broadcast (ADS-B) equipment, has gained increasing importance as a means of providing critical information relative to the aircraft operating within that system (FIG. 1-1).

In general, transponder-equipped aircraft reply on a 1090 MHz carrier frequency to interrogations received on a 1030 MHz carrier from traditional secondary surveillance radar stations and from ADS-B ground stations. The 1090 MHz transmissions are pulse position-modulated in several different possible patterns or “modes,” depending on the type of interrogation sent by the ground station. A summary of the capabilities of the various secondary surveillance devices is found in Table 1-1; the transmission modes are further described below.

TABLE 1-1
Secondary Surveillance Equipment Characteristics

| | | | | GPS | |
|---|---|---|---|---|---|
| | 4 digit | Unique | | Position | |
| | Variable | ICAO | | and | Transmission |
| | Identifier | Identifier | Altitude | Velocity | Trigger |
| Mode A | X | | | | Interrogation |
| | | | | | Only |
| Mode C | X | | X | | Interrogation |
| | | | | | Only |
| Mode S | | X | X | | Interrogation |
| SS | | | | | Squitter |
| Mode S | | X | X | X | Interrogation, |
| ES | | | | | Squitter |
| UAT | | X | X | X | Squitter Only |

Mode A is an identification-only mode that transmits a four-digit octal code to the interrogating station. In addition to the four-digit code, Mode C also responds with barometric altitude information that is encoded using a modified Gray code. Mode A and Mode C interrogations are specific to the response mode desired and are normally interlaced by ground stations.

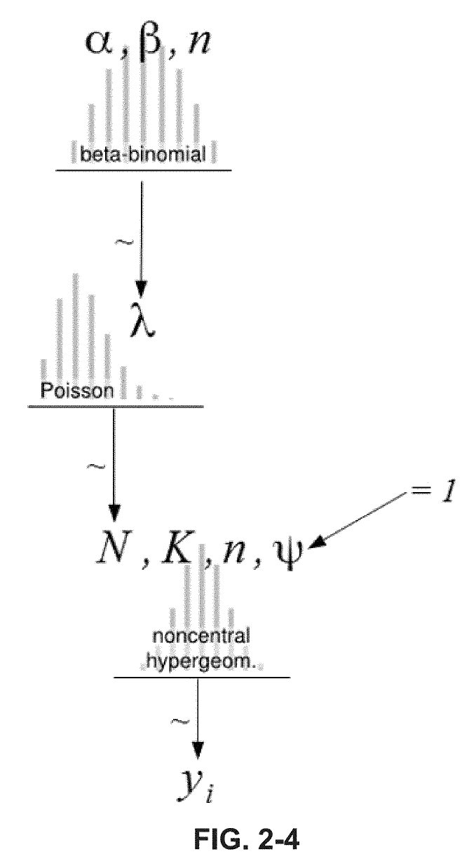

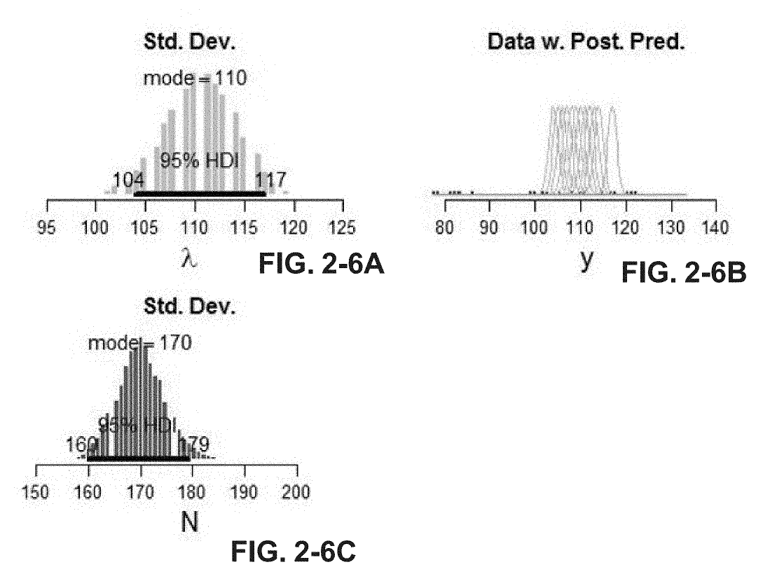

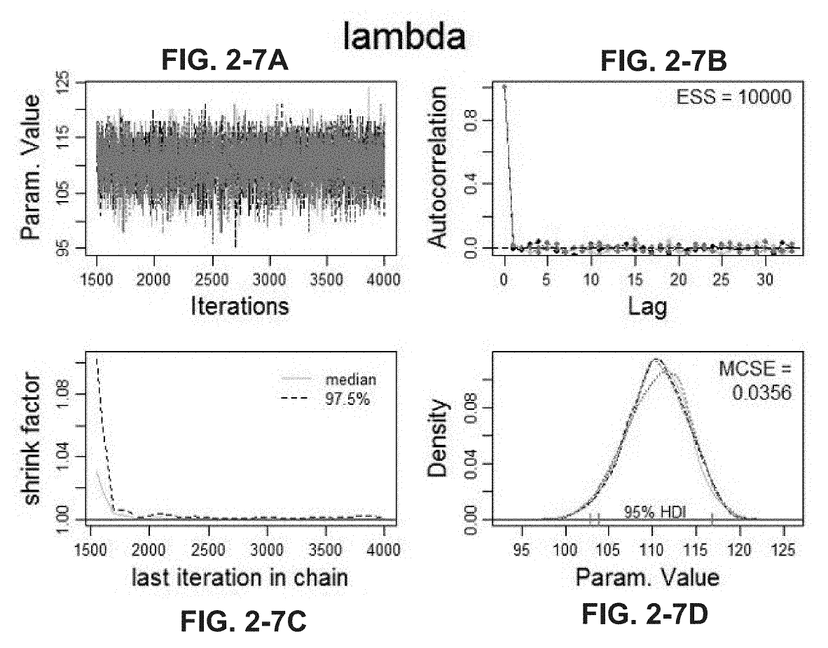

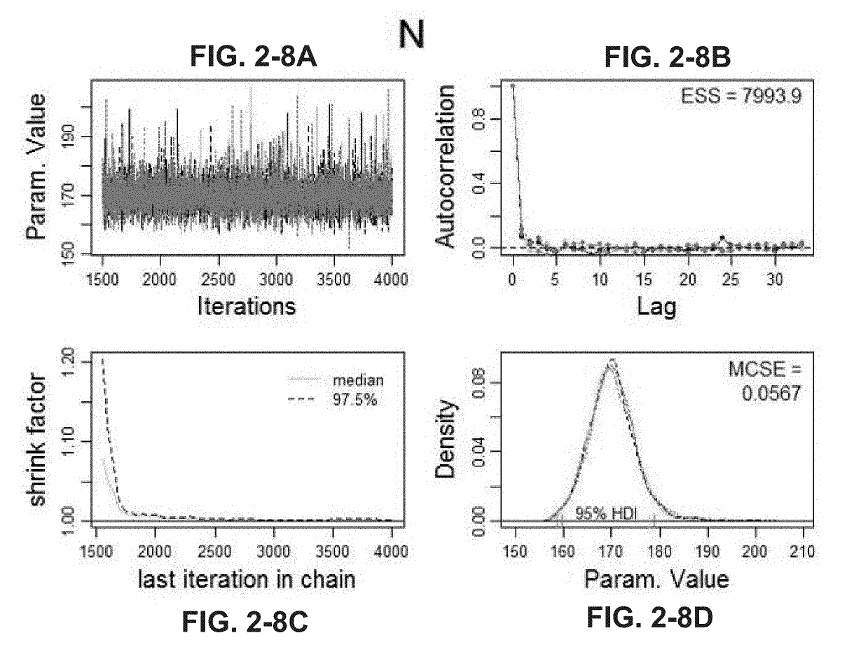

One aspect of both Mode A and Mode C transponder equipment is that responses from the equipment can be initiated by interrogation from ground-based radar stations. It follows, then, because of the inherent challenges associated with maintaining a reliable data link, that these modes lack utility when aircraft operate at low altitudes at long distances from the station. A station may lose the ability to interrogate an aircraft descending into the traffic pattern at an airport that is located at the limit of its range. For example, FIG. 1-2A illustrates an aircraft equipped with a Mode C transponder on approach to an airport during which radar and secondary surveillance coverage is lost. In this example, the aircraft is invisible to radar and secondary surveillance interrogations while on the ground (FIG. 1-2B); coverage is regained once the aircraft reaches an appropriate altitude on climb-out (FIG. 1-2C).

Mode S replies append to the altitude code a 24-bit code issued by the International Civil Aviation Organization (ICAO) that is used to identify the aircraft transmitting the replies. In the United States, there is a unique, one-to-one correspondence between this ICAO code and the FAA aircraft registry. Mode S also has the ability to act as a squitter; that is, as a device that can initiate data transmissions without being interrogated by a ground station, Mode S SS (short-squitter) transponders transmit only the altitude and ICAO codes in response to Mode S interrogations, while Mode S ES (extended-squitter) units reply with extended squitter data containing an additional 56-bit data field used for communicating GPS-based position, velocity, and altitude information.

Because of the ability of Mode S transponders to squit (transmit data without interrogation), the need for ground-based interrogation is obviated. Hence, an aircraft equipped with Mode S and descending to pattern altitude at a considerable distance from the radar station will continue to transmit the short-squit or extended-squit data, depending upon how it is equipped, even when the interrogating signal is lost (FIG. 1-3A). The Mode S-equipped aircraft transmits its squitter data while on the ground below conventional radar and secondary surveillance coverage (FIG. 1-3B) and on departure (FIG. 1-3C). This makes Mode S signals useful for providing information on general aviation aircraft operating at airports that are not located in the vicinity of a ground-based radar facility.

Yet another embodiment of the present invention includes a modified algorithm for those occasions in which extended squitter is not available. Because Mode C and Mode S short squitter responses do not contain position or heading information, aircraft position can be determined from received signal strength indication (RSSI) data. Once an appropriate threshold detection level has been determined, the RSSI trend for the particular aircraft can be measured. Aircraft with increasing RSSI and altitudes below that of the traffic pattern altitude are presumed to be engaged in an operation. A barometric pressure transducer is incorporated to provide an input to the Raspberry Pi; this information is used to convert altitude data from Mode C and Mode S short squitter responses, reported with respect to a standard presume datum of 29.92 inches or 1013.25 millibars, to AGL altitudes for comparison with traffic pattern altitudes. Alternatively, the computer can be provided the ambient barometric pressure at the airport from data provided by the airport or other sources, such as over the Internet.

Once the counts from the Mode S extended squitter and Mode C/Mode S short squitter data are established, they, along with the raw transponder data, are recorded in a data logging device. In some embodiments, the data logging device does not record counts. Rather, it records the raw transponder data stream. These entries (one per aircraft transmission) are processed by the software on the server into counts.

When the data logging device is within range of a WiFi network, the device connects automatically to a server and uploads the data to the server to serve as input for the estimation algorithm. The estimation software resides on the server and can be run independently of the uploading procedure.

The problem of estimating the size, N, of the population of operations at a particular airport over a particular time, in which the ratio of the rate of aircraft arrivals, λ, to the sample size, n, is relatively small (generally less than 0.1), is essentially the German tank problem. This problem relates to determining the total number of serialized units of equipment in existence if a sample of those units is observed (captured) and the serial numbers of the samples are available to the observer. Statistically, the size of a discrete, finite population that is uniformly (rectangularly, initially, although that constraint can be relaxed to allow an improper distribution; that is, one that does not integrate to 1 over its limits) distributed by sampling without replacement is desired. The constraint that the sampling occur without replacement is useful as airport operations are unique.

The problem can be formulated using a Frequentist approach. Given n observations, and a maximum count of x across all n observations, the minima variance unbiased estimator (MVUE) e of N, where N is the total number of unique items being counted, is given by Equation 2-1.

$$e = ( \frac{n + 1}{n} ) x - 1 \qquad ( 2 \text{-} 1 )$$

Simulations can be used to illustrate the inaccuracies associated with estimating the population size by the sample maximum when sampling without replacement from a discrete uniform distribution. In this example, N, the population size, equals 500, as might be appropriate as a monthly operations count for a small airport. Note in FIG. 5-1 that as n, the number of observations, increases, the distribution of the sample maximum converges to N (and x is thus a consistent estimator of N), but that there is a large variance in the distribution when n is small.

FIG. 5-2 shows the effect of the application of the minimum-variance estimator on the convergence described above. The figure shows that there is a reasonably smooth decline in the variance of the estimate as n approaches N.

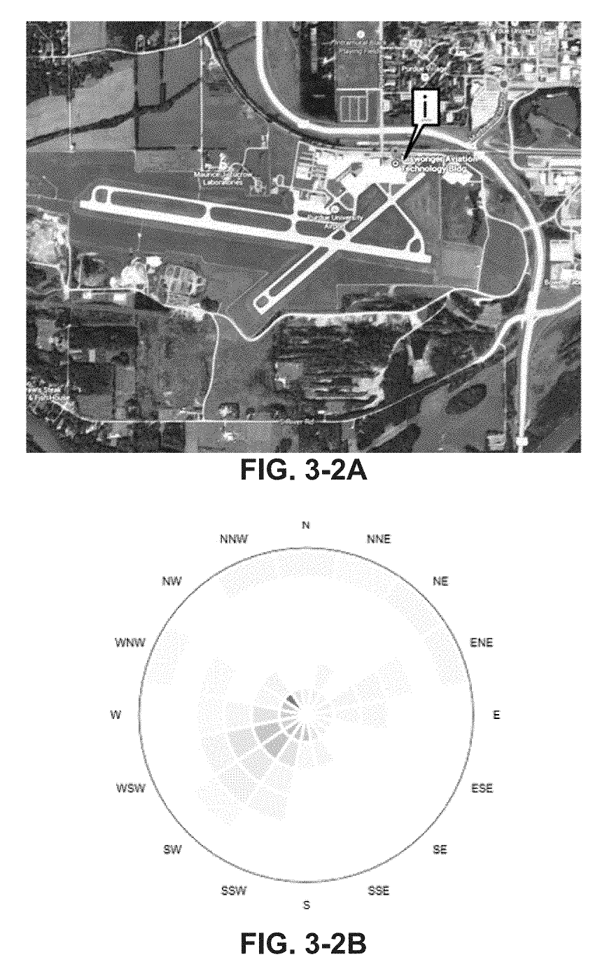

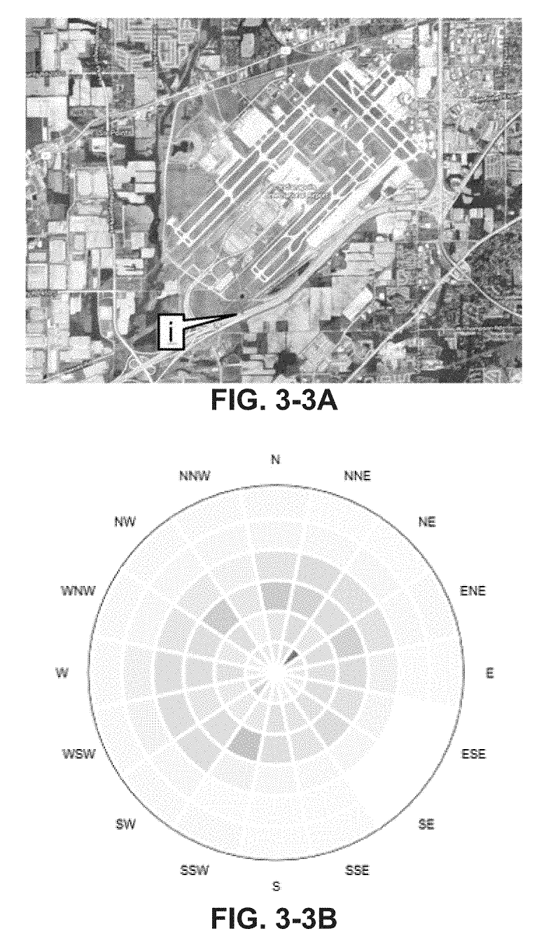

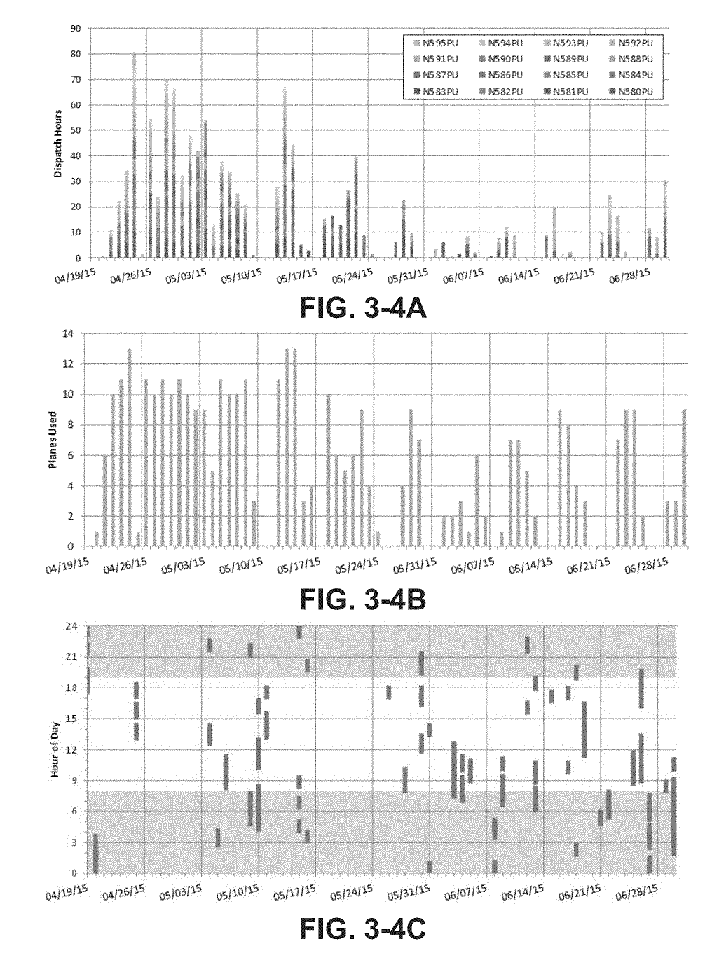

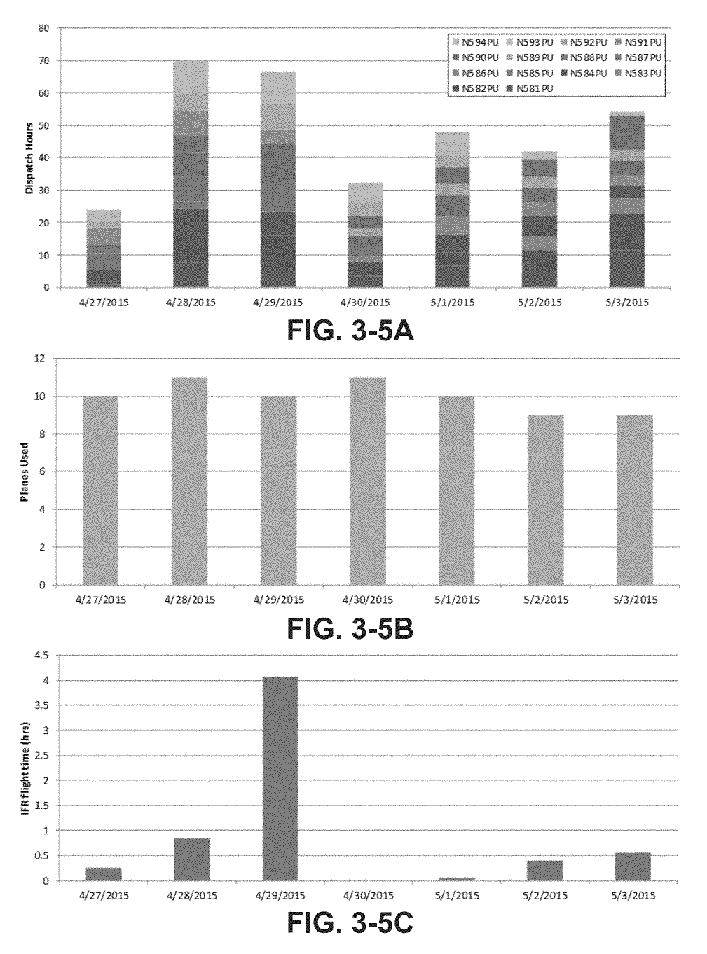

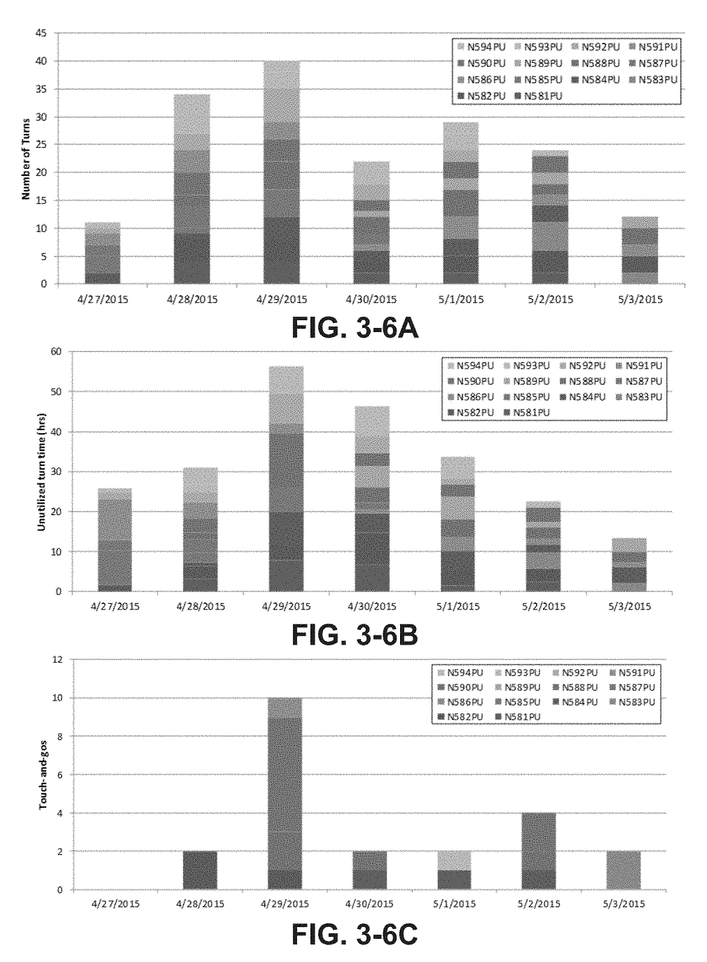

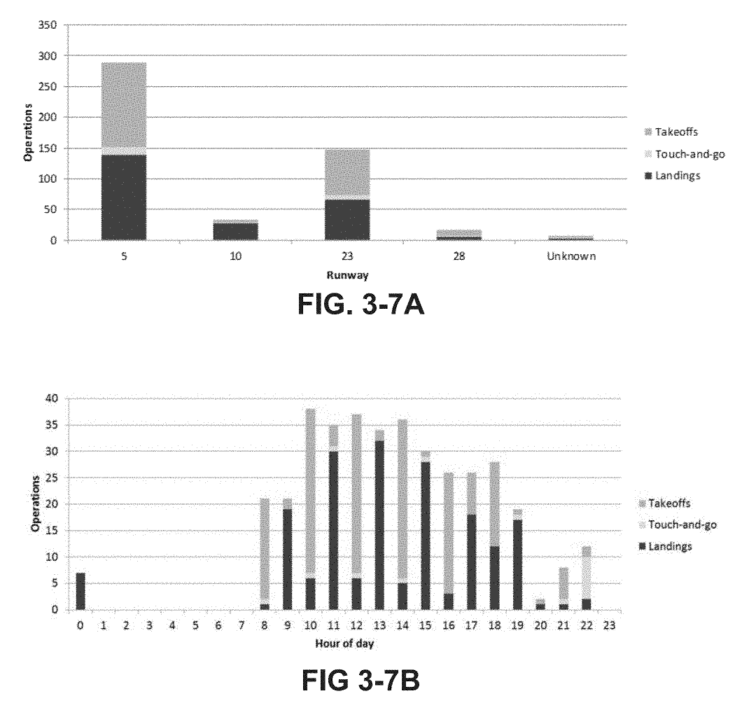

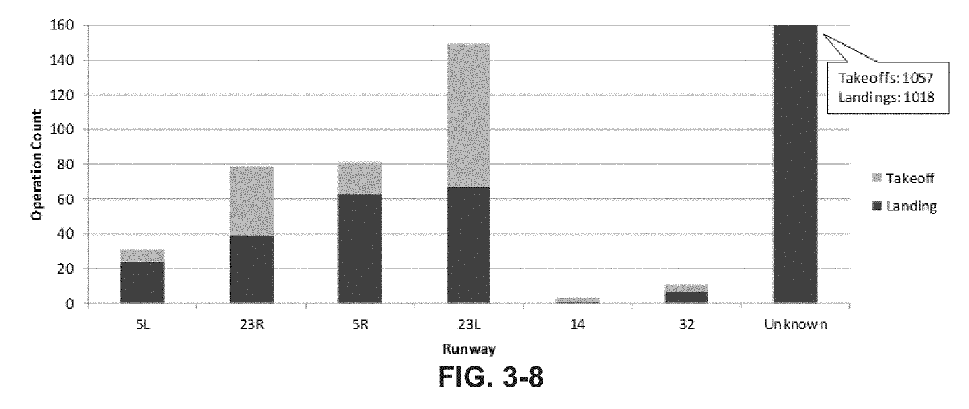

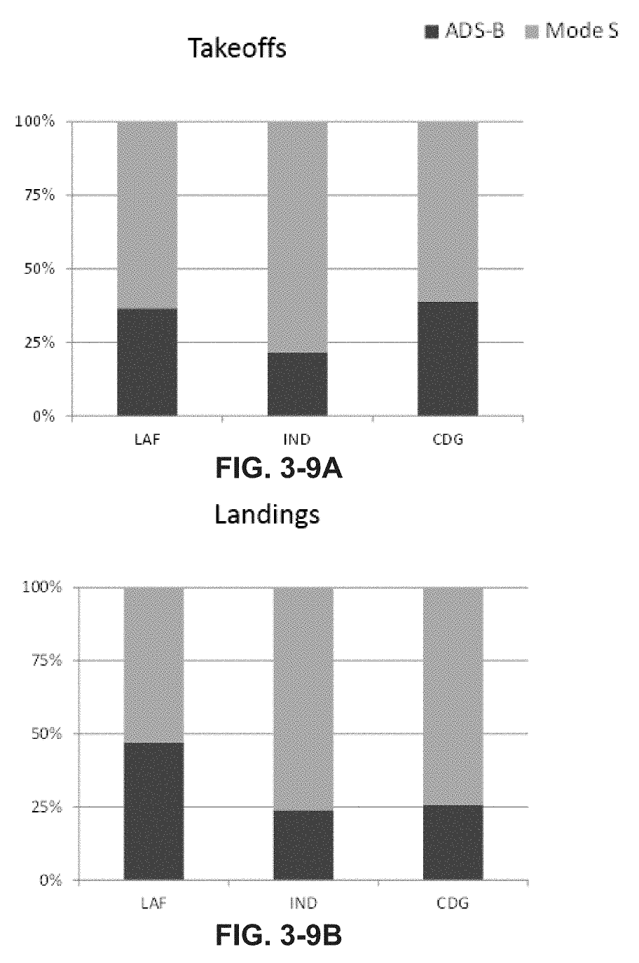

FIG. 5-3 shows the mean squared error of the minimum variance unbiased estimator relative to the maximum observed value in the sample. Note again that the difference is greatest for small values of n.

Two modifications to the estimation procedure are suggested here. The first employs a Frequentist model based on sampling without replacement from a discrete, finite, uniformly-distributed population. The second involves a Monte Carlo simulation and associated Bayesian hierarchical model using a Poisson likelihood function, which incorporates the inherent Poisson nature of the underlying arrival process and assumes uncertainties in the registration of operations counts, The latter approach is shown to improve substantially the accuracy of both the traditional, unmodified predictor and the Frequentist modification.

One aspect of the minimum-variance estimator suggested above is a characteristic that is common to all such estimators; that is, maximum likelihood estimation assumes that the population mean has fixed (unknown) value. It is useful to examine Bayesian estimation in this context, as the Bayesian method does not assume a fixed value for the population mean; rather, it treats the mean as a random variable having a probability distribution. Sampling allows us to estimate the mean of that distribution and other useful statistics, by calculating a posterior distribution, which is proportional to the likelihood multiplied by a prior distribution. If θ represents the parameter to be estimated and X is a vector of observations, this may be written as

(θ|X)∝(X|θ)(θ) (2-4)

The Bayesian approach to the problem under consideration provides us with two distinct advantages over the maximum likelihood methodology. First, because it provides a distribution (the posterior) for the parameter being estimated, not only a point estimate of the parameter, but a “credible interval,” or range of values associated with a particular probability that the parameter lies within the specific range. The credible interval is analogous to the confidence interval in Frequentist statistics, but differs in an important respect, in that the confidence interval does not describe the probability with which a parameter lies within a given range of the population, but only of a particular sampling distribution; that is, the confidence interval is valid only for a particular sampling distribution, thereby limiting its usefulness.

The German tank problem can be examined in a Bayesian framework, using an improper uniform prior distribution, in which the requirement that the prior integrate to 1 is relaxed. The posterior distribution in this specific case is given by

$$p ( N \vert x ) = \frac{n - 1}{x} ( \begin{matrix}x \\ n\end{matrix} ) {( \begin{matrix}N \\ n\end{matrix} )}^{- 1} , \\ N = x , x + 1 , … \qquad ( 2 \text{-} 5 )$$

It follows from the distribution that the mean and variance are given by

$$\begin{matrix}E ( N \vert x ) = \frac{n - 1}{n - 2} ( x - 1 ) , n > 2 & ( 2 \text{-} 6 ) \\ and & \\ {σ}^{2} ( N \vert x ) = \frac{( n - 1 ) ( x - 1 ) ( x - n + 1 )}{{( n - 2 )}^{2} ( n - 3 )} , n > 3 & ( 2 \text{-} 7 )\end{matrix}$$

respectively. The widespread availability of open-source software that can run Markov Chain Monte Carlo (MCMC) simulations to provide posterior distributions and credible intervals based on observed data provides a relatively straightforward procedure to obtain the desired results. This method will be utilized to develop estimates for N in the following sections.

A variation of the German tank problem is proposed, in which all observed events that may be tentatively considered operations will be serialized, but in which only those event that can be classified with a predetermined level of certainty as operations will be included in the data vector. For example, the set A={1, 4, 7, 8, 10, 14} indicates as many as 14 operations that may have occurred, but only six that occurred with an acceptable level of certainty. It is easy to see that the sequence of all six elements of A is strictly increasing.

The overall distribution for this problem is discrete and is the hypergeometric distribution, which describes the selection of n items without replacement from a set of N items where K items are of one type and N−K items are of a second type. The probability mass function is defined by

$$P ( X = x ) = \{ \begin{matrix}\frac{( \begin{matrix}K \\ x\end{matrix} ) ( \begin{matrix}N - K \\ n - x\end{matrix} )}{( \begin{matrix}N \\ n\end{matrix} )} , & x ∈ S \\ 0 , & otherwise\end{matrix} \qquad ( 2 \text{-} 8 )$$

where S∈ [symbol] such that x≤n, x≤K, and n−x≤N−K.

Consider K to be the number of operations observed by a measuring device, and assume that K includes both operations that exceed a particular predetermined level of certainty that is utilized during the measurement and classification process, and operations that do not exceed this level. Define N as the number of actual operations. The number of operations unobserved by the measuring device is then N−K.

When formulated for Bayesian Monte Carlo Markov Chain simulation, the likelihood function is simply the pmf in (2-8). This is because, while the likelihood function is defined in vector form as

[symbol]

(θ|x)=f(x1|θ)×f(x2|θ)× . . . ×f(xn|θ), (2-9)

the scalar form of the function is the proper form to specify in the model, because the Gibbs sampling algorithm used in the simulation handles the multiplication in (9) internally.

Assume that the arrival process is a counting process that may be modeled as a homogeneous Poisson process. Suppose that (t) is a discrete random process representing the total number of aircraft operations on a given runway. By definition, (t)∈ [symbol] ≥0. Also, (t)≥N(s)∀t≥s;t,s≥0.

In order for the process to be Poisson, it should satisfy

$$\begin{matrix}{lim}_{Δ t -> 0} P ( N ( t + Δ t ) - N ( t ) > 1 \vert N ( t + Δ t ) - N ( t ) \geq 1 ) = 0 & ( 2 \text{-} 10 ) \\ and & \\ P ( N ( t ) > x \vert N ( s ) > x ) = P ( N ( t ) > x ) & ( 2 \text{-} 11 )\end{matrix}$$

for all x∈ [symbol] ,t,s ∈[0,∞). The first of these conditions places upon the process the constraint that operations cannot occur simultaneously, and the second includes that the number of operations occurring in any bounded interval of time (s, t) is independent of the number of operations occurring at or before time s. Note that (t) as defined in this manner is a Markov process. Note also that the assumption of homogeneity is appropriate because the variation in process arrival rates in this particular application tends to be long-term in nature; i.e., having a period several orders of magnitude greater than the order of magnitude of the rates themselves.

The Bayesian hierarchical model, then, consists of a hypergeometric likelihood function with two higher-order priors (FIG. 2-4).

The number of operations, N, is the primary parameter of interest in the estimation, and is characterized as a Poisson-distributed random variable with rate parameter λ. The rate parameter, which represents the arrival process mean, is itself a random variable. The weakly informative prior is preferred over both an informative prior and a least-informative prior, as the former will influence the posterior distribution to an extent that is unwarranted by the a priori information available, while the latter can lead to algorithm convergence issues and may be improper, which can lead to impropriety of the posterior (i.e., ΣP(N(t)=k)≠1,k∈k{0,1,2 . . . }).

Because the standard Cauchy distribution or the equivalent Student's t distribution with one degree of freedom are both continuous the beta-binomial distribution was chosen for this reason. The α and β parameters were set such that this top-level hierarchical prior is weakly informative.

Due to the manner in which the serialization is accomplished, the value of the parameter K in the likelihood function may potentially exceed the maximum value in the data vector. For this reason, the minimum-variance unbiased estimator adjustment described previously is employed. K then becomes

$$K = ( \frac{n + 1}{n} ) max ( x \vert ) - 1 \qquad ( 2 \text{-} 12 )$$

where x is the data vector. Incorporation of this factor for the value of xmax in the model ensures that values of x greater than max(x) are allowable.

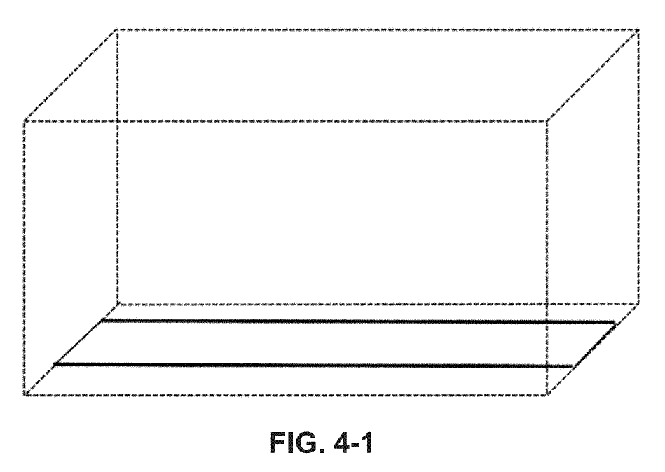

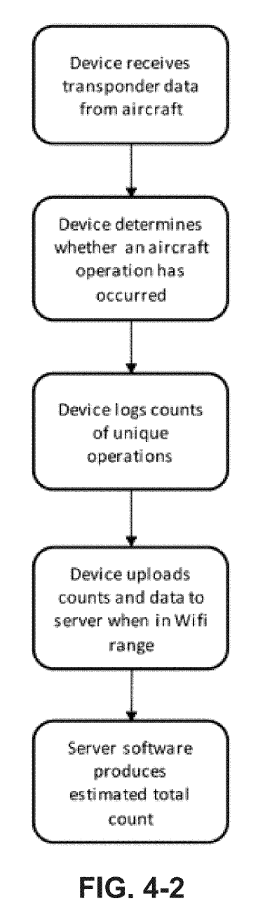

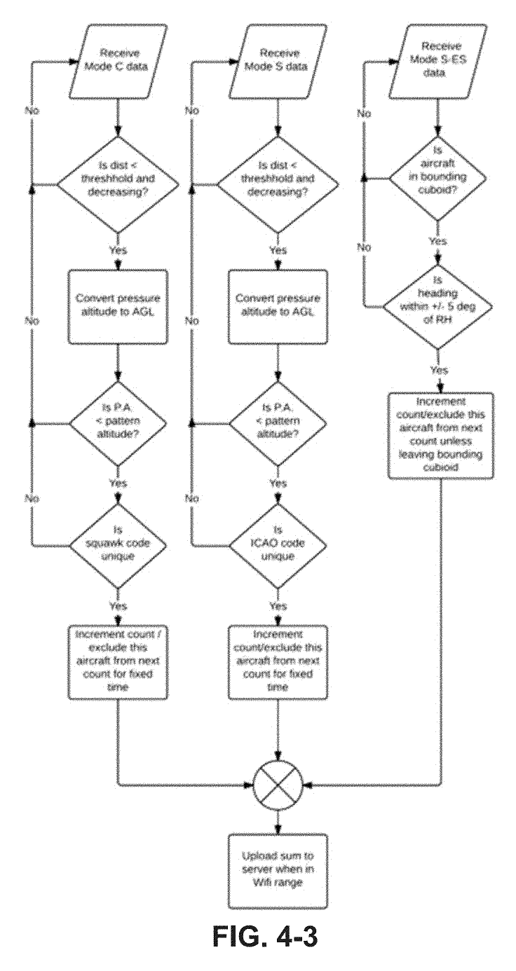

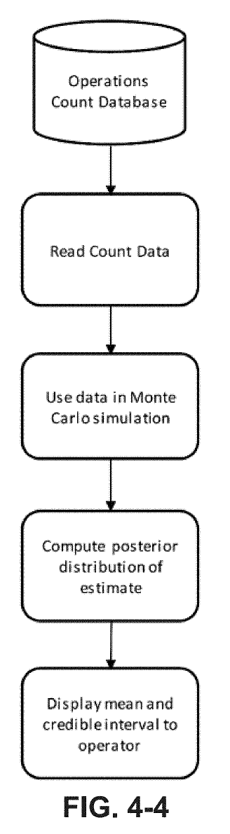

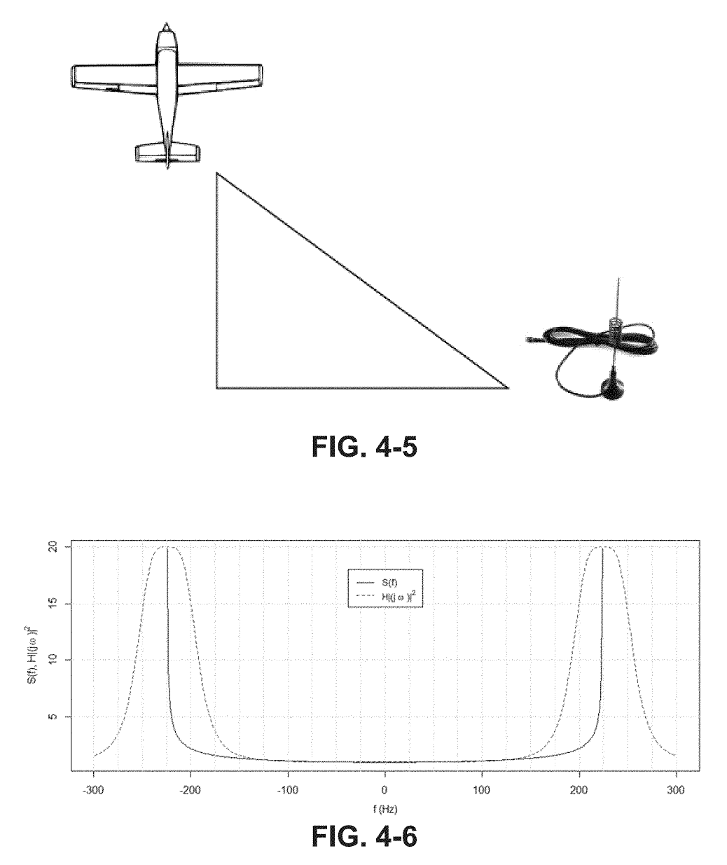

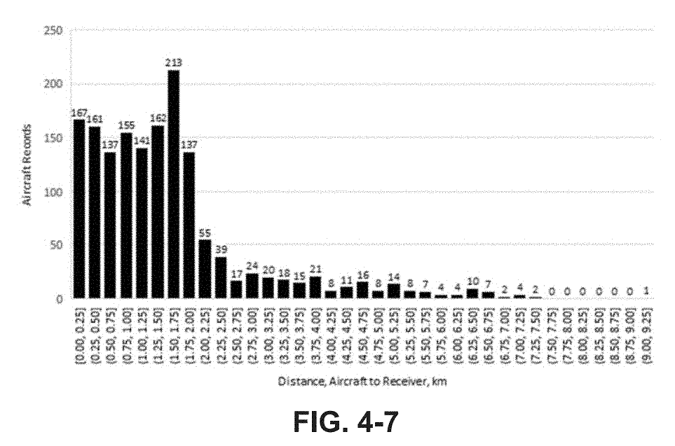

The hierarchical model was implemented using R and the JAGS Monte Carlo simulation package. Because of a lack of flexibility of the noncentral hypergeometric distribution provided in the JAGS package with respect to the parameters being estimated, one embodiment of the present invention includes a new distribution function using exponential functions and logarithms of factorial functions for use in the simulation. FIG. 4-4 describes the process flow in terms of how the model might be incorporated in software.

The data for testing the hierarchical model was acquired using a novel receiver and data logging device according to another embodiment of the present invention. This device uses aircraft transponder signals as the input to an algorithm that determines whether the particular aircraft from which those signals are received is engaged in an airport operation. The device was deployed near the Lafayette Airport (KLAF), located at Purdue University in West Lafayette, Ind.

The counting device recorded a total of 122 operations a period, of which 48 were categorized as “certain.” Certain operations consisted of those in which the GPS coordinates of the aircraft fell into a bounding box containing one of the two runways at the Purdue airport and the aircraft heading matched that of the runway, with both conditions existing for a predetermined period of time. Measured operations, then, for which both of these criteria were not met were not coded as “certain.” A data vector for use in the prediction algorithm was created by serializing each measured operation with its actual serial number (1 through 122) if the operation was certain, and with a zero otherwise.

Employing the conventional frequentist estimation procedure, a reasonable approach for handling the count data is by representing it with a binomial probability mass function, since the individual operations observations are dichotomous (either “yes” or “no”) with respect to the certainty of the operation. The binomial pmf is given by

$$( \frac{n}{k} ) {{p}^{k} ( 1 - p )}^{( n - k )} , \qquad ( 2 \text{-} 13 )$$

where n is the number of trials (samples, in this case), k is the number of “successes,” (certain operations), and p is the success probability in each trial. In this case, p is the is ratio of certain operations to samples, or 0.393. The mean of the pmf is given by np, or 48, which is the operations estimate. The confidence interval is

np±t\sqrt{np(1−p)}, (2-14)

or 48±10.68 operations. It is clear that this estimate deviates significantly from the actual number of 188 operations. Note that if the information regarding the measurement uncertainty is discarded, the estimate simply becomes the count total, or 122, but that the confidence interval is indeterminate because of the fact that there is a single sample.

The conventional estimate can be potentially be improved by introducing the minimum-variance unbiased estimator (1). The MVUE estimate, assuming the measurement uncertainty is again discarded (as it can be, since the estimate is defined only for x≥n), is, from (1), 122, but note that the confidence interval is again not defined.

TABLE 2-1
Parameter Estimates

| | Mean | Median | Mode | ESS | HDImass | HDIlow | HDIhigh |
|---|---|---|---|---|---|---|---|
| Lamba | 110.52 | 111 | 110.10 | 10000 | 0.95 | 104 | 117 |
| N | 170.25 | 170 | 170.00 | 8148.7 | 0.95 | 160 | 179 |

Table 2-1 shows the estimates of the arrival rate (Lambda) and operations counts (N). The operations count estimate of 171 (170.25 rounded up) is within 10% of the total validated operations count of 188, which lies just outside the 95% credible interval for the parameter (indicated by HDllow and HDlhigh in the table).

The Bayesian prediction algorithm was run using the data vector described earlier, which accounts for the certainty of a portion of the operations measurements and lack of certainty of the remainder. Two parameters were estimated: the arrival rate for observed operations (lambda), and the number of total operations (N). The results of the Monte Carlo simulation are presented here in Table 1 and in FIGS. 2-6A, 2-6B, and 2-6C through FIGS. 2-8A, 2-8B, 2-8C, and 2-8D.

The quantities in the ESS column are the effective sample sizes for the respective parameter estimate. These values are good; an ESS value that is too low indicates a high degree of autocorrelation in the MCMC chains used in the simulation.

FIGS. 2-6A, 2-6B, and 2-6C show the posterior distributions of the parameters A and N, and of the observations (y). The two credible intervals of the parameter estimates are displayed, as well.

FIGS. 2-7A, 2-7B, 2-7C, 2-7D and FIGS. 2-8A, 2-8B, 2-8C, and 2-8D provide additional computation details for parameters λ and N. The upper-left graph in each figure, parameter value vs. iterations, provides an indication of the variance of the estimated values about the mean as a function of the number of iterations in the chains. The autocorrelation, upper-right, shows the degree of correlation of the selected posterior samples, and is inversely related to the effective sample size. The shrink factor graph indicates the rate of convergence of the estimates to the mean. The posterior distribution of the respective parameters is shown in the lower-right graph, as is the Monte Carlo standard error (MCSE). The MCSE values are low for both parameters being estimated.

In the United States in calendar year 2014, the general aviation fleet, consisting of all civilian aircraft except those airliners engaged in operations under 14 CFR 121, totaled 204,408 aircraft (FAA 2015). Approximately 72% of the aircraft in the general aviation fleet were equipped with Mode C transponders (FIG. 1-4), while 18% of those aircraft had some form of Mode S transponder or UAT (universal access transceiver, a type of device intended for general aviation aircraft flying at low altitudes) installed. Of these 18%, half (or 9% as a percentage of the total fleet) were equipped with Mode S short-squitter units, 7% with Mode S extended-squitter, and 2% with UAT. The two latter categories of units constitute ADS-B (automatic dependent surveillance—broadcast) devices.

While it is relatively straightforward to collect Mode S ES data (with its associated aircraft position information) and to use this data to determine aircraft position relative to a particular runway, the airspace penetration of Mode S ES transponders is only about 7%, despite an FAA requirement that all domestic aircraft be equipped with some form of ADS-B transmitter (either Mode S ES or UAT) by Jan. 1, 2020, Because of this lack of Mode S ES data penetration in domestic airspace, it is reasonable to attempt to utilize the low-cost transponder data collection unit to estimate airport operations counts by making use of Mode S SS and Mode C data, as the combined airspace penetration of those devices is approximately 81% Since neither of these data types contains aircraft position information, positions can be estimated using a combination of the signal amplitude and reported aircraft barometric altitude.

The use of the signal amplitude and barometric altitude parameters to determine aircraft position relative to a runway poses some challenges. The received signal is subject to scattering effects from atmospheric phenomena such as clouds and precipitation, multipath interference, variation in received frequency due to Doppler effects related to aircraft velocity, and receiver noise. According to one embodiment of the present invention, the accuracy of the estimation of aircraft proximity, however, can be improved through the use of a self-tuning Kalman filter based on known Mode S ES aircraft locations; the concept here being that the variation due to scattering, velocity, and receiver noise can be determined given known aircraft position data, and those estimates used to tune the filter parameters such that the distances of the aircraft not transmitting position information can be better estimated. In addition, barometric altitude as reported in the aircraft data stream should be corrected for local fluctuations in atmospheric pressure, In some embodiments of the present invention, a software defined radio proximate to the airport receives data from a local barometric pressure sensor. That sensor can provide a direct input to the SDR; in some embodiments however the data is provided by Wi-Fi or other link from a source at the airport.

The device according to one embodiment of the present invention used to collect the transponder data consists of a small, single-board computer (Raspberry Pi) using an ARM-based processor that runs Linux and a USB software-defined radio (FIG. 1-5). The SDR is a NooElec NESDR device employing a Realtek RTL2832U demodulator in conjunction with a Rafael Micro R820T tuner. This hardware can either be permanently installed and powered by a 110 VAC connection and networked with an Ethernet cable, or it can be configured for portable deployment with a battery pack and no Internet connection, The structure of the device and a picture of the portable field deployment are shown in FIG. 1-4. The data are collected by the antenna and SDR, processed on the Raspberry Pi, and stored on the SD card. Optionally, LEDs may be used to show the status of the computer when it is not connected to a monitor, and an Internet connection can provide the ability to upload the data to a central database. The software running on the Raspberry Pi was adapted from the open source software Dump1090, a tool for receiving and decoding messages from the SDR, to provide the SD card logging, LED indications, and SQL interface.

A potential method for estimating operations, according to one embodiment of the present invention, counts employs a relative frequency model based on sampling without replacement from a discrete, finite, uniformly-distributed population. This method can be shown to improve estimates of the count parameter for small sample sizes (n<50). However, yet other embodiments pertain to an improved method of estimating operations counts based on the output of the transponder data collection device. This improved method involves a Markov Chain Monte Carlo (MCMC) simulation and associated Bayesian hierarchical model using a Poisson likelihood function, which incorporates the inherent Poisson nature of the underlying arrival process and assumes uncertainties in the registration of operations counts. The latter approach is shown to improve substantially the accuracy of both the traditional, unmodified predictor and the Frequentist modification. This model preferably is coded in R, an open-source software that is widely used for statistical analysis. In a trial over a limited number of samples collected during a single day at the Purdue University Airport, the estimation procedure produced results that were within 10% of the manually-verified total count of operations.

One performance indicator (a business metric used to evaluate factors essential for an organization's success) proposed for measurement of the operational efficiency of the Purdue primary flight training program is the fleet cumulative turn time (FCTT). Aircraft turn times for a given day are measured from the first time an aircraft is observed in operation to the last time that aircraft is observed on the particular day. The fleet cumulative turn times, then are simply the sum of these figures across the training aircraft fleet, This metric presents a total picture of the operational efficiency of the fleet.

The improvements are targeted at the demand side of the equation; i.e., to using available aircraft time more efficiently. A linear programming technique designed to assign scheduled flights to available aircraft more efficiently than has previously been accomplished has been implemented, The results of the modified dispatch scheduling procedure need to be validated, and an ideal way to do so includes the use of the transponder data collection device. The data are stored in an SQL database and is available for analysis in both dashboard form and through downloadable MS Excel spreadsheets. These data may be used to determine the FCTT metric for any particular day, and therefore play a key role in the validation of the dispatch model.

A pilot test over three days of operation of the new scheduling model was conducted, and the resulting data was analyzed by comparing pre- and post-test mean turn times using both a traditional ANOVA and its Bayesian equivalent. Both of these tests showed a significant difference in means, with a decrease in the mean FCTT evident from pre-test to post-test. This is indicative of an improvement in the overall dispatch process resulting from the implementation of the model.

The use of Mode S extended squitter transponder data in conjunction with aircraft GPS-derived position information for distance determination is relatively straightforward, but empirical observations in the U.S. and Europe indicate that only approximately 25-30% of aircraft broadcast Mode S ES signals. Data published by the Aerospace Electronics Association indicates that the actual percentage of Mode S ES-equipped aircraft in the U.S. is substantially less; as of March, 2015, only 10,949 domestic aircraft were equipped with Mode S ES equipment out of approximately 204,000 aircraft on the federal registry, or about 5.5%. As noted previously, the FAA (2015) places this figure at 7% at the end of CY 2014. Regardless, however, of the precise penetration percentage, the salient point is that the more prevalent Mode S SS and Mode C signals contain aircraft position information limited to barometric altitude only (Table 1-1) and therefore the estimation of the proximity of the aircraft to the receiver is a problem to be addressed.

Mode S SS and Mode C equipment will be in use for some time to come. Because of this, the need to employ the use of Mode S SS and Mode C signals in the aircraft operations counting process is evident. Various embodiments focus on a means of extracting distance information from Mode S short squit and Mode C aircraft transponder signals using an algorithm that does not rely on multilateration; that is, sufficient information for determination of the proximity of the aircraft should ideally be provided by a single receiver and collection unit installed in the field. Other embodiments include a means of employing a low-cost ground-based transponder data collection unit to facilitate the estimation of the proximity of an aircraft equipped with a Mode S SS or Mode C transponder by using signal strength information provided by the unit.

The software 100 to examine received data and perform the estimation process will be coded in R, due to that language's open-source nature and provision of applicable statistical routines. The overall proposed algorithm is displayed as a block diagram in FIG. 1-7.

The data output of the software-defined radio-single board computer combination 20 comprises in one embodiment eight closely chronologically-spaced values of relative signal strength for each transponder transmission that is received. Generally, these transmissions are received every few seconds; the interval between transmissions is, however, irregular and dependent on the frequency of interrogations from ground-based secondary surveillance radar stations and of uninterrogated Mode S squitter transmissions, These plurality of values constitute a signal strength vector that may be combined into a single scalar quantity that can, in turn, be used to represent the signal strength in the manner described below.

It is instructive to plot the relative signal strength values produced by the SDR-Raspberry Pi combination as one attempts to examine the relationship between the values over time and correlate them with aircraft positions relative to the ground-based receiver. FIGS. 1-8A-1-8G, 1-9, and 1-10 provide an example of this process, depicting relative signal strengths over a 130-second period on a particular day at the Purdue University Airport (KLAF) as they relate to the departure of a Cirrus SR20 training aircraft from the field. During this interval, the particular aircraft producing the signals (N580PU) departed on a runway in a direction away from the receiver (prior to 3838 seconds, the time at which the data displayed in FIG. 1-9 was first collected), turned and climbed in the runway traffic pattern opposite the receiver, passed by the receiver, and continued its departure from the airport area.

The signal strength vector, consisting of the eight values of relative signal strength output from the single-board computer, is first converted to an absolute received voltage vector (VREC), which represents the amplitude of the signal envelope.

A refined estimate of the received voltage vector may be obtained by passing VREC through an adaptive Kalman filter. This filter will serve to account for the shift in the Doppler power spectral density of the signal as a result of the aircraft velocity relative to the receiver, for uncertainties in the transmission channel due primarily to multipath interference, and for noise generated by the software-defined radio and processing electronics. The basic Kalman filtering process according to one embodiment is shown in FIG. 1-11.

One of the challenges of Kalman filtering is that the process and observation noise covariance matrices are often unknown, as is the case here. Fortunately, the distance estimate, [symbol] can be utilized with the Mode S ES data, which provides exact position information for the signal source from which accurate distances can be calculated, to optimize the coefficients of both the process error function, ξ=f(δ)), the covariance matrices Q and R, and the output matrix H. This is done with a multipara meter optimization function in R. The result is an adaptive filtering process that can be optimized over large data sets to yield the desired levels of accuracy of [symbol] . It is important to realize that the tuning of the filter in an optimal manner based on existing environmental and positioning conditions can occur in a dynamic manner such that the approximately 7% of aircraft broadcasting Mode S ES data with position information can influence the filter parameters for the 81% of aircraft broadcasting either Mode C or Mode S short squit signals.

The scattering is assumed to be predominately Rayleigh-distributed. Rayleigh scattering is associated with atmospheric phenomena such as precipitation, haze, and clouds, and with multipath; both result in a relatively weak line-of-sight signal component. Some have proposed a deterministic fourth-order state-space model for Rayleigh fading channels that approximates small-scale fading due primarily to multipath. The relative velocity of the aircraft being tracked results in a spreading effect of the channel which is captured its Doppler power spectral density (DPSD). The approximate transfer function \tilde{S}(s)=H(s)H(−s) is

$$\tilde{S} ( s ) = \frac{{K}^{2}}{{s}^{4} + 2 {{ω}_{n}}^{2} ( 1 - 2 {ζ}^{2} ) {s}^{2} + {{ω}_{n}}^{4}} , \qquad ( 1 \text{-} 1 )$$

where K, ωₙ and ζ are the gain, natural frequency and damping coefficient, respectively. The real portion of the transfer function is

$$H ( s ) = \frac{K}{{s}^{2} + 2 ζ {ω}_{n} s + {{ω}_{n}}^{2}} \qquad ( 1 \text{-} 2 )$$

in which the three parameters, K, ζ, and ωₙ can be adjusted in such a manner as to cause the transfer function to conform to the measured characteristics of the channel.

The second-order stochastic differential equation represented by the real portion of the channel transfer function, (s), is

$${d}^{2} x ( t ) + 2 ζ {ω}_{n} d x ( t ) + {{ω}_{n}}^{2} x ( t ) = Kq ( t ) . \qquad ( 1 \text{-} 3 )$$

This can be transformed into the following state equations

E\dot{x}=Fx+Q (1-4)

z=Hx+R (1-5)

where

$$E = [ \begin{matrix}1 & 0 \\ 0 & 1\end{matrix} ] , \dot{x} = [ \begin{matrix}\dot{x} \\ \ddot{x}\end{matrix} ] , and F = [ \begin{matrix}0 & 1 \\ - {{ω}_{n}}^{2} & - 2 ζ {ω}_{n}\end{matrix} ] .$$

The filter prediction equations for the corresponding discrete Kalman filter are then

xₖ₋₁=Fxₖ (1-6)

Pₖ₊₁=FPₖF^{T}+Q (1-7)

and the update equations are

K=Pₖ₊₁H^{T}(HPₖ₊₁H^{T}+R)^{31 1} (1-8)

xₖ=xₖ₊₁+K(zᵢ−Hxₖ₊₁) (1-9)

Pₖ=Pₖ₊₁−Pₖ₊₁H^{T}K^{T} (1-10)

The initial coefficients are determined by calculating fmax, the maximum Doppler shift, using the first two data values of the received signal vector, x, to determine the derivative. The initial value of fmax then determines F. Q is set as

$$Q = [ \begin{matrix}Var ( x ) & 0 \\ 0 & Var ( \dot{x} )\end{matrix} ] \qquad ( 1 \text{-} 11 )$$

and H=[1 0] and R=0.5. The coefficients of the second row of the F matrix are then adjusted dynamically, based on updated values of E0, the magnitude of the signal envelope, and fmax. Intuitively, this serves to adjust the degree of channel spreading due to variations in aircraft velocity.

The signal channel model can utilize a scalar signal strength as its input. This value should be estimated from the Kalman-filtered received voltage vector, and the estimator used is simply the maximum likelihood estimator for the Rayleigh-distributed scattering in the channel. Because the Weibull distribution is a generalized version of the Rayleigh distribution, the former is used in the actual software coding according to one embodiment.

Once the scalar signal strength parameter has been estimated from the Kalman-filtered received voltage vector, it is converted into a power and serves as input to a deterministic channel model represented by the Friis transmission equation, which represents various power losses in the transmission channel. The distance estimate, [symbol] , is obtained directly from this equation.

The transmitter proximity estimate can be combined with barometric altitude information extracted from the Mode S SS or Mode C data to determine whether the aircraft is engaged in an airport operation; i.e., a takeoff or landing (FIG. 1-12).

Data has been collected and statistically processed according to various embodiments of the present invention using inventive devices and inventive methods described herein. A portable device and antennae have been installed at LAF. Two permanent antennas have been installed at the Indianapolis (Indiana) International Airport (IND). These installations have higher gain antennae and are connected to the Internet. For the permanent installations at IND and LAF, those records are inserted in real time into an SQL database for real-time web page monitoring. For the shorter-term

Paris Charles de Gaulle Airport (CDG) installation, those records were inserted into the database after field data collection was completed. During field data collection, no filtering occurs and all data are captured. The approximate numbers of records stored in the SQL database for the LAF, IND, and CDG data collection sites are 48,000, 75,000, and 23,000, respectively.

FIG. 3-2A shows the location of the LAF antenna relative to the runways at the airport, along with a polar plot showing the relative distances of the aircraft positions received. Each ring represents a span of 60 statute miles, radiating from the antenna at the center. Darker colors show more positions reported from that location. This installation uses an indoor antenna placed in an office window facing southwest. FIG. 3-2B shows a concentration of position reports in a general southwest direction related to attenuation associated with the building structure for signals coming from other polar directions.

The IND installation consists of a 4-ft outdoor omnidirectional antenna placed with a line of sight to the airfield, outside airport property, as shown in FIG. 3-3A. The accompanying polar plot illustrates the differences in reception that both unobstructed placement and antenna gain can make. The red segment to the northeast illustrates the relatively large proportion of observations associated with aircraft that use IND. Positions are reported from all directions around the antenna, with good coverage out to 240 mi. For Jun. 24, 2015, a total of 525,598 positions were collected from 3,307 aircraft. Just over 5% of those position reports were in the red portion of the polar plot shown in FIG. 3-3B.

The three graphs in FIGS. 3-4A, 3-4B, and 3-4C give an overview of fleet utilization. For a fleet of 16 aircraft with six 2-h instructional flight blocks, an upper bound on dispatch hours is approximately 172 h per day. FIG. 4A shows the dispatch hours by day, colored by aircraft registration number. There was significant use from mid-April through mid-May, which declined when the semester ended on May 9. The maximum was 80.8 dispatch hours on April 24, and the average was 16.0 h with a median of 8.6. The second graph, FIG. 3-4B, tallies the total aircraft used each day. In the first month, the 16 aircraft were utilized fairly evenly, although the most used in 1 day was 13. For the entire period, the average number of aircraft used was 5.2, with a median of 5, which is less than half the fleet.

The third graph, FIG. 3-4C, shows the hours of low-visibility conditions and was constructed with data from the air support operations squadron facility at the airport. Low visibility was defined as less than three statute miles, the minimum visibility for visual flight rules (VFR) flight in Class B, C, D, and E airspace. The gray bands indicate nighttime hours, from 00:00 to 08:00 and from 20:00 to 24:00. Those days with several hours of low visibility generally correspond to days with less flight activity. For example, on June 26 there were 5 h of low visibility during daytime hours and no aircraft were dispatched. In contrast, only the early morning hours of June 30 had low visibility. After the weather cleared, the day had 30.3 dispatch hours from nine aircraft.

FIGS. 3-5A, 3-5B, and 3-5C provide a more detailed view of fleet utilization and focuses on the week of Monday, April 27, to Sunday, May 3, a week with no weather restrictions and relatively high fleet use. The graphs in FIG. 3-5A and FIG. 3-5B, show the total dispatch hours by registration number and the number of aircraft used each day. The total dispatch time varied between 24 and 70 h, and between nine and 11 aircraft were used each day, On any given day there were at least four unused aircraft, and two aircraft, N580PU and N595PU, were not used at all that week because of maintenance. The third graph, FIG. 3-5C, illustrates the time these planes spent flying under instrument flight rules (IFR). In this week, the weather was generally VFR, so the IFR flying was likely related to instructional activities.

FIGS. 3-4A, 3-4B, and 3-4C suggest there may be opportunities to improve fleet utilization. Several performance measures can be considered for either identifying opportunities for efficiency improvement or monitoring the type of instructional activity for which an aircraft is used. One such metric is the number of times per day a particular aircraft is turned or dispatched for subsequent instructional flights after the first flight of the day.

Because there are six standard 2-h instructional flight blocks in a typical day, a typical upper bound on turns per day would be 80 if all flight slots and aircraft were used. FIG. 3-6A shows the number of turns by aircraft, suggesting that not all flight slots are used. Table 3-1 shows the dispatch hours by tail number and flight slot for 2 days, April 27 and 28, which were days of low and high utilization, respectively. Flight slots are 2-h blocks, beginning with Slot 1 between 01:30 and 03:30. On the first day, only 10 aircraft were used, four for only one slot. On the second day, in contrast, one more plane was used but there was vastly more utilization overall. Six aircraft were used in each flight block, and two more were used in five of the six daytime blocks.

FIG. 3-6B shows the total time spent during those turns, when the aircraft was not transmitting data. Time between flights is not a perfect measure because a certain amount of ground time is spent fueling the aircraft and performing pre- and post-flight activities with the aircraft not powered on and no ADS-B messages being transmitted. However, FIG. 3-6B does suggest some merit in monitoring unutilized ground time,

From the perspective of program and fleet management, there is some utility in monitoring aircraft operations. FIG. 3-6C illustrates touch-and-go activities for the fleet for a week. The algorithm includes debouncing of the aircraft squat switch (the switch that signals whether the aircraft is on the ground or in the air) to eliminate most erroneous readings from bouncy landings. The number of touch-and-go activities is higher at LAF than expected at a commercial airport because of the high proportion of training operations.

FIG. 3-7A shows the operations by runway. LAF has two runways, which can be seen in FIG. 3-2A; Runway 10/28 is 6,600 ft. long and Runway 5/23 is 4,225 ft. long. Only seven operations could not be matched to a runway, two because of headings that did not match any runways and five that had matching headings but the GPS point was not within the predetermined runway box.

FIG. 3-7B displays the same operation counts by hour of day for weekdays. The hours alternate having mostly landings and mostly takeoffs because time on the aircraft is allocated in 2-h blocks. Therefore, most of the aircraft departing in the 11:00 hour arrive in the 12:00 hour before the block ends at 13:00, for example. The greatest utilization occurs during the middle of the day, corresponding to an 08:00-to-19:00 workday, and students desiring night hours favor the later slots rather than early morning.

Referring to FIG. 1-5B, the equipment was deployed adjacent to the IND, which is the second largest hub for FedEx (FIG. 3-3A). IND has two parallel runways, 5L/23R (11,200 ft. long) and 5R/23L (10,000 ft. long), as well as a crosswind runway, 14/32 (7,280 ft. long). The same process was used to match takeoffs and landings, with operations that have matching heading and GPS values assigned to a runway and all others counted as unknown. FIG. 3-8 shows the counts by runway; the counts for the unknown runway are given in a box so that the axis remains scaled to show the matched runway count. Runway 5R/23L is closest to the FedEx hub and has the most activity, particularly during evening hours.

Although most of the fleet transmits only in Mode S, a count of operations can be taken by tracking altitude and squat switch transitions. More detailed Mode S extended data allows for matching to the runway and could eventually track approach and taxiing behaviors.

Although Jan. 1, 2020, is the FAA deadline for providing ADS-B out, many aircraft do not yet transmit ADS-B data. For an indication of where the air traffic system is with ADS-B penetration, FIGS. 3-9A and 3-9B display the percentage of aircraft that transmitted ADS-B versus standard Mode S (altitude and ICAO identifier only) at three airports: LAF, IND, and CDG.

The differences between takeoffs and landings at LAF can be attributed to the time it takes to obtain a GPS lock, which frequently does not occur until after takeoff. At IND, these values are closer together as this effect is likely mitigated by longer taxiing times. CDG has nearly double the ADS-B readings as IND for takeoffs, perhaps reflecting the greater acceptance of ADS-B in Europe. The drop between takeoffs and landings at CDG may be an artifact of antenna position that allowed good visibility of only runways 09R/27L and 091127R.

As the NextGen 2020 deadline for ADS-B out approaches, the percentage of ADS-B reporting aircraft is expected to rise. The FAA advised all operators to operate transponders whenever the aircraft is in a movement area at any airport. This measure is meant to transition pilots into the NextGen system, where a combination of multilateration and ADS-B will provide data for air traffic control and FAA compliance monitoring systems. As pilots respond to this advisory, the data captured with the device can be expanded to taxiing activity, and the resulting sample size will be a larger percentage of the actual traffic at a given airport.

TABLE 3-1
Dispatch Hours by Flight Block

| | Dispatch Hours for Apr. 27, 2015, by Flight Block | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Aircraft | Nighttime | | | Daytime | | | | | | Nighttime | | |
| N581PU | | | | | .07 | | | | | | | |
| N582PU | | | | | 1.35 | | | | | | | |
| N583PU | | | | | | | | | | | | |
| N534PU | | | | 1.35 | 0.97 | 1.05 | | | | | | |
| N585PU | | | | | 1.22 | 1.42 | 0.12 | 0.15 | | | 2 | 0.32 |
| N586PU | | | | | | | | | | | | |
| N587PU | | | | 0.17 | 0.32 | 0.67 | | | | | | |
| N588PU | | | | | 1.1 | | | | | | | |
| N589PU | | | | | | | | | | | | |
| N590PU | | | | | | | | | | | | |
| N591PU | | | | 1.73 | 0.17 | 1.28 | | | | | 2 | 0.27 |
| N592PU | | | | | 1.02 | 1.07 | | | | | | |
| N593PU | | | | | | 1.18 | | | | | | |
| N594PU | | | | | | 0.95 | 1.02 | 0.13 | | | | |

| Dispatch Hours for Apr. 28, 2015, by Flight Block | | | | | | | | | | | |
|---|---|---|---|---|---|---|---|---|---|---|---|
| 1 | 2 | 3 | 4 | 5 | 6 | 7 | 8 | 9 | 10 | 11 | 12 |

| | | | |
|---|---|---|---|
| Aircraft | Nighttime | Daytime | Nighttime |

| | | | | | | | |
|---|---|---|---|---|---|---|---|
| N581PU | 1.08 | 1.23 | 1.52 | 1.48 | 1.3 | 1.02 | |
| N582PU | 1.02 | 1.38 | 1.8 | 1.35 | 1.15 | 1.17 | |
| N583PU | | | | | | | |
| N534PU | 0.18 | 2 | 2 | 1.47 | 1.57 | 1.52 | |
| N585PU | 1.08 | | 1.23 | | | | |
| N586PU | | | | | | | |
| N587PU | 1.17 | 1.27 | 2 | 0.97 | 1.05 | 0.82 | |
| N588PU | | 1.57 | 1.4 | 1.7 | 1.72 | 1.38 | |
| N589PU | | | | | | | |
| N590PU | | 1.48 | 0.65 | 1.13 | 0.88 | 1.03 | |
| N591PU | 1.27 | 0.7 | 1.42 | 1.47 | 1.3 | 0.57 | 0.13 |
| N592PU | | 1.35 | 1.4 | 1.15 | 0.25 | 0.63 | |
| N593PU | | | 0.27 | 1.38 | | 1.13 | |
| N594PU | 0.2 | 0.83 | 1.28 | 1.07 | 0.8 | 1.38 | |

A means of counting operations according to one embodiment using Mode S extended squitter aircraft transponder data received with a 1090 MHz software-defined radio system has been developed. One embodiment of the present invention presents a method for estimating distance information from the latter two types of transponder signals, enabling them to be used by the SDR-based device, along with Mode S ES signals, in the operations counting process. The distance estimation method described here is based on an adaptive Kalman filter incorporating parameter optimization using known distance information from Mode S ES signals, and results in an average error of 0.83 nm in measurements within a 5.0 nm radius of the receiver, This level of uncertainty enables the use of Mode S short squit and Mode C signals to count aircraft operations at airports without the additional overhead of multilateration.

For comparison, the raw signal level data from the same file consisting of 1588 records was used to predict distances using only the maximum likelihood estimator and the derived deterministic equation (4-31). The function (6) is in this case linear and derived from an analysis of the open-source software that handles much of the communication functions for the SDR. The scaling logic in that software sets the signal level as

(δ)=−365.4798+258,433254. (4-52)

Representing (δ) as a α+βδ and solving (52) for δ, α=1.414214 and β=0.003869.

Using the preceding process, the value of etotal for the 1588 points was determined to be 11628.28, a greater than 4.75-fold increase over the error metric obtained through the use of the optimized internal error model and adaptive filtering algorithm.

The signal estimation algorithm described here yields a substantial improvement in distance estimation accuracy over an approach using maximum likelihood estimates of the signal level values without the adaptive filtering process. The suggested parameter optimization methodology is especially effective in reducing distance prediction errors, as it employs position information from the smaller proportion of aircraft that transmit such information in order to more accurately estimate the distances of the larger number of aircraft without this capability.

In one aspect this signal processing technology is used in conjunction with Mode C and Mode S receiving and logging technology as a validation tool. Since, currently, Mode S ES technology exhibits relatively low nationwide penetration rates, the algorithm will allow the extension of the operations counting and validation techniques to a much broader range of aircraft that are equipped only with Mode C or Mode S short squit transponders.

The motivation for this research was the development of a model that processes data from a software-defined radio-based device which records signals from transponder-equipped aircraft and, through the use of signal processing algorithms, determines whether those aircraft are engaged in airport operations.

Various embodiments of the present invention include means for extracting distance information from Mode S short squit and Mode C aircraft transponder signals using a newly-developed algorithm that does not rely on multilateration; that is, sufficient information for distance determination can be provided by a single receiver and collection unit installed in the field. A stochastic channel model and adaptive Kalman filtering process is preferably used alongside a channel parameter optimization method to produce aircraft distance estimates that are of sufficient accuracy to be used to determine whether operations involving those aircraft are occurring at the particular airport of interest.

The transponder signals providing the input to the receiver are broadcast from aircraft in motion at nontrivial velocities relative to the ground-based receiving antenna. The transmission channel itself is prone to atmospheric effects, multipath (small-scale fading), and shadowing (large-scale fading). Various channel models may be appropriate at different times, depending on the transmitter-receiver geometry and atmospheric propagation effects. The measuring device itself is subject to nonlinear signal processing errors, including quantization error. Variation among individual aircraft with respect to transmitter power and signal losses plays a role, as well. The net result of these challenges is that the estimation of aircraft distances from single-receiver data includes careful analysis and the use of effective signal processing tools if it is to provide meaningful information.

Various embodiments of the present invention pertain to an algorithm that processes Mode S extended squitter and Mode S, Mode A and Mode C data output by a 1090 MHz software-defined radio in conjunction with a Raspberry Pi single-board computer running Dump 1090 software. The Mode S extended squitter portion of the algorithm utilizes known geographic coordinates to create bounding cuboids (FIG. 1) for runways for which operations are to be estimated.

The coordinates for aircraft being observed are compared regularly to determine whether they are contained within the runway cuboid 30. If the reported AGL (above ground level) altitude of the aircraft is below the traffic pattern altitude for the airport, the aircraft's coordinates lie within the horizontal plane of the cuboid, and the aircraft's reported heading matches the runway orientation within 5 degrees, an operation is presumed to have occurred. Once the first operation for the unique identifier is reported, none other is registered until the aircraft has left the bounding cuboid and exceeded the traffic pattern altitude for a prescribed period of time. The overall process is depicted in FIG. 4-2.

Because Mode C and Mode S short squitter responses do not contain position or heading information, aircraft position should be determined from the strength of the received signal. Once an appropriate threshold detection level has been determined, the distance trend for the particular aircraft can be measured. Aircraft with decreasing distances and altitudes below that of the traffic pattern altitude are presumed to be engaged in an operation. A barometric pressure transducer is incorporated in one embodiment to provide an input to the Raspberry Pi; this information is used to convert altitude data from Mode C and Mode S short squitter responses, reported with respect to a standard presume datum of 29.92 inches or 1013.25 millibars, to AGL altitudes for comparison with traffic pattern altitudes. The decision logic for this process is depicted in FIG. 4-3.

Once the counts from the Mode S extended squitter and Mode CA/lode S short squitter data are established, they are recorded in a database to serve as input for the Bayesian estimation algorithm. This code implements a hierarchical Bayesian model utilizing a weakly-informative prior that is normal with zero mean and large variance. The resulting estimate is an excellent approximation of the operations count over the specified period of time (FIG. 4-4).

The software-defined radio receiver used in the counting device is based on an integrated circuit that serves as a DVB-T coded orthogonal frequency division multiplexed signal demodulator, in conjunction with a separate integrated circuit tuner. Signal strength information is derived from the magnitudes of the in-phase and quadrature components of the signal, and is represented as a fraction of full-scale power in a single byte.

According to FAA Technical Standard Order C74c, for aircraft operating at altitudes greater than 15,000 feet, transponder output power can be between 21 and 27 dB above 1 W. This implies an output power of 125.89 W to 501.19 W. For aircraft operating below these altitudes, the specification is for output power between 18.5 and 27 dB above 1 W, implying an output power of between 70.79 W and 501.19 W. In practice, virtually all transponders meet the former specification.

It is well-established that received radio frequency power decreases as 1/d2. The free space path loss can be written as

$$FSPL = {( \frac{4 π df}{c} )}^{2} \qquad ( 4 \text{-} 1 )$$

where d is the distance between the transmitter and receiver, f is the carrier frequency (1090 MHz, in this case) and c is 2.998 m/s. The UHF band (300-3000 MHz) generally exhibits direct propagation, which one may assume with regard to an overall propagation model, exclusive of fading. In addition, assume that tropospheric ducting is not present.

The Friis transmission equation is given by

$${P}_{REC} = {P}_{TRANS} + {G}_{t} + {G}_{r} + 20 log \sqrt{\frac{1}{FSPL}} \qquad ( 4 \text{-} 2 )$$

where the antenna gains are in dB and power is in dBm. Rearranging (4-2):

$$d = {10 [ \frac{( {P}_{TRANS} - {P}_{REC} - 32.44 - 20 log f - other gains )}{20} ]}^{2} \qquad ( 4 \text{-} 3 )$$

where d is given in km and fin MHz. The other gains and losses in (3) involve the gains of the transmitting and receiving antennas and the insertion loss. The insertion loss is small and straightforward to calculate. The impedance into the SDR is ZR=75, while the receiving antenna impedance is ZA=50 Ω. The reflection coefficient, ρ, is

$$ρ = \frac{25}{125} = 0.2 \qquad ( 4 \text{-} 4 )$$

and the insertion loss is then

Loss_{INSERTION}=−10 log(1−ρ²) (4-5)

or −0.177288 dB.

The ground distance between the aircraft and the receiver can be determined from the estimate of the line-of-sight distance and the aircraft altitude, as shown in FIG. 4-5. The ground distance is simply

d_{GROUND}=\sqrt{d_{LOS}²−═²}, (4-6)

where a represents the aircraft altitude, a parameter readily available from Mode S short squitter and Mode C transmissions.

The line-of-sight distance is essentially a random process with a deterministic component (the fixed path loss) and a random variable representing fading.

It is reasonable to consider a stochastic channel model to analyze small-scale effects due to scattering and multipath for the development of the overall mathematical model that will be used to estimate the transmitter distance, Two such models are commonly used: the Rayleigh fading model and the Rician model. The Rician model is more appropriate when there is a strong line-of-sight component to the received signal, while the Rayleigh model applies when no such component it present. The assumption here is that, because the aircraft of interest are operating at low altitudes close to the receiver, the line-of-sight signal component is limited, and consequently the Rayleigh model is preferred. Accordingly, that model is used in the remainder of the analysis.

The Rayleigh model is parameterized with a single parameter, σ2, which is proportional to the average power of the received signal envelope. The Rayleigh probability density function is

$$f ( x ) = \frac{x}{{σ}^{2}} {e}^{- \frac{{x}^{2}}{2 {σ}^{2}}} . \qquad ( 4 \text{-} 7 )$$

A more general form of the Rayleigh distribution is the Weibull distribution, the probability density function of which is given by

$$f ( x ) = \frac{k}{λ} {( \frac{x}{λ} )}^{k - 1} {e}^{- {( \frac{x}{λ} )}^{k}} \qquad ( 4 \text{-} 8 )$$

with parameters k and λ. Equating the parameters in Equations (4-4) and (4-5), it is readily apparent that k=2, and λ=√2σ. These relationships allow the use of the Weibull distribution in the JAGS package in R for modelling the channel. It should be noted that the parameterization of the Weibull distribution in JAGS is different from hat used in the conventional pdf (Equation (5) above). In the JAGS parameterization,

$${λ}_{JAGS} = \frac{1}{2 {σ}^{2}} . \qquad ( 4 \text{-} 9 )$$

Note that k in (4-5) corresponds to v in the JAGS distribution. It should also be noted that the Weibull distribution describes the variation of received signal strength, not the received power. The average local power is then the variance of the Weibull distribution, which is

$$\begin{matrix}{P}_{{AVG}_{W}} = 2 {σ}^{2} ( Γ ( 2 ) - {Γ ( 1.5 )}^{2} ) \\ = 2 {σ}^{2} ( 1 - {0.8862269}^{2} ) \\ = \frac{0.2146019}{{λ}_{jags}} .\end{matrix} \qquad ( 4 \text{-} 10 )$$

The average received power in dBm is

$${P}_{{AVG}_{dBm}} = 10 log {P}_{{AVG}_{W}} = 10 log ( \frac{.2146019}{λ} ) + 30. \qquad ( 4 \text{-} 11 )$$

The distance estimation process becomes:
1. Record values of δ, the signal level output by the SDR device
2. Filter the δ values to estimate the signal.
3. Using the filtered δ values as the data vector, estimate the Weibull distribution parameter λ using JAGS.
4. Calculate the average received power from (4-11).
5. Find the line-of-sight distance from (4-3).
6. Find the ground distance from (4-2).

Selecting a weakly informative prior distribution having a mean of

$$\frac{1}{{\overline{{y}^{2}}}_{i}} ,$$

where yi is the data vector, and a standard deviation of sd(y), for use in the Bayesian Markov Chain Monte Carlo estimate of the λ parameter in the JAGS parameterization of the Weibull distribution (Equation (4-6)), yields the maximum likelihood estimator for that parameter,

$${\hat{λ}}_{JAGS} = \frac{1}{\frac{1 \vert}{N} {\sum }_{i = 1}^{N} {y}_{i}} . \qquad ( 4 \text{-} 12 )$$

This estimator can be used as a calculation in software to avoid the complexity of incorporating the Bayesian MCMC estimator in the process.

Again, because the altitudes of the aircraft of interest are small because those aircraft are close to the receiver, assume that the ground distance is approximately equal to the line-of-sight distance, Those distances can be validated in the case of Mode S Extended Squitter messages by comparing the distance estimates with the actual reported aircraft positions in relation to the ground station.

The Haversine formula for determining the distance between two points of known latitude and longitude was utilized in this study. The applicable set of equations is

$$\begin{matrix}{d}_{LON} = {lon}_{2} - {lon}_{1} & ( 4 \text{-} 13 ) \\ {d}_{LAT} = {lat}_{2} - {lat}_{1} & ( 4 \text{-} 14 ) \\ a = {sin}^{2} ( \frac{{d}_{LAT}}{2} ) + cos ( {lat}_{1} ) cos ( {lat}_{2} ) {sin}^{2} ( \frac{{d}_{LON}}{2} ) & ( 4 \text{-} 15 ) \\ d = 2 R * {sin}^{- 1} ( √ a ) & ( 4 \text{-} 16 )\end{matrix}$$

where R is the radius of the Earth, 6373.2 km.

The SDR unit outputs 8-bit in-phase (I) and quadrature (Q) samples to the software running on the host device; these are converted to a magnitude as

δ=\sqrt{I²+Q²}. (4-17)

Aircraft transponders use a form of Manchester-encoded pulse amplitude/pulse position modulation, which can be easily received by the QAM receiver in the Rafael unit. Only the real portion of the baseband signal is transmitted on the 1090 MHz carrier. The SDR tuner uses a low-intermediate frequency (3.57 MHz) architecture, and is connected only to the in-phase analog-to-digital converter input, implying that the software-defined radio circuit generates the complex samples through its internal IF demodulator. One benefits of this approach is that there is no DC offset spike as would be present if the heterodyne approach were not utilized.

It is assumed that the actual signal level is some (nonlinear) function of the parameter δ in (4-17). This function accounts for gain and offset after the point at which the scaled and quantized I and Q values are received by the host device, and is incorporated to model (1) processing that occurs in the host device software, and (2) variation between individual units.

In general, for quadrature amplitude-modulation, the received waveform is

s(t)=I(t)cos ωt−Q(t) sin ωt (4-18)

and

s²(t)=I²(t)cos²ωt−2I(t)Q(t)cos ωt sin ωt+Q²(t)sin²ωt. (4-19)

To calculate the RMS value S, assume that I(t) and Q(t) are constant over a cycle, Then

$$\begin{matrix} {s}^{2} ( t ) = {I}^{2} {cos}^{2} ω t \vert - 2 IQ cos ω t sin ω t + {Q}^{2} {sin}^{2} ω t & ( 4 \text{-} 20 ) \\ \int {s}^{2} ( t ) dt = {I}^{2} ( \frac{t}{2} + \frac{{sin}^{2} 2 ω t}{4 ω} ) - 2 IQ ( \frac{{sin}^{2} 2 ω t}{2 ω} ) + {Q}^{2} ( \frac{t}{2} - \frac{{sin}^{2} 2 ω t}{4 ω} ) & ( 4 \text{-} 21 ) \\ \frac{1}{T} {\int }_{0}^{T} {s}^{2} ( t ) dt = \frac{{I}^{2}}{2} + \frac{{Q}^{2}}{2} \\ so & ( 4 \text{-} 22 ) \\ {S}_{RMS} = \frac{1}{\sqrt{2}} ( \sqrt{{I}^{2} + {Q}^{2}} ) \\ and & ( 4 \text{-} 23 ) \\ {P}_{AVG} = \frac{1}{2 R} ( {I}^{2} + {Q}^{2} ) & ( 4 \text{-} 24 )\end{matrix}$$

where R is the real part of Z0, the characteristic impedance of free space, or 376.73 Ω.

Now let ξ be a deterministic function of δ, the signal level byte value, adjusted for gain and offset adjustments and variation between individual units as noted previously. Then

$${P}_{IND} = f ( {P}_{AVG} ) = \frac{1}{2 R} {f ( δ )}^{2} {=}^{Δ} \frac{{ξ ( δ )}^{2}}{2 R} . \qquad ( 4 \text{-} 25 a )$$

The maximum gain of the SDR tuner is 49.6 dB has measured the relationship between indicated power and actual received power at maximum gain. That function is

P_{IND}=0.988P_{REC}+88.52 (4-25b)

where PIND is the power in dBm indicated by the output of the RTL2832U as read by accurate spectrum analyzer software and PREC is actual measured received power in dBm.

Then

P_{REC}_{_{dBm}}=1.012146P_{IND}_{_{dBm}}−89.59514 (4-26)

and, from (4-25)

$$\begin{matrix}{P}_{{IND}_{W}} = \frac{{ξ ( δ )}^{2}}{2 R} = \frac{{ξ ( δ )}^{2}}{753.46} \\ and & ( 4 \text{-} 27 ) \\ \begin{matrix}{P}_{{IND}_{dBm}} = 10 log ( \frac{{ξ ( δ )}^{2}}{2 R} ) + 30 \\ = 20 log ξ ( δ ) + 1.229398 .\end{matrix} & ( 4 \text{-} 28 )\end{matrix}$$

### Then

P_{REC}_{_{dBm}}=20.243 log ξ(δ)−88.350810 (4-29)

and

$$\begin{matrix}{P}_{{REC}_{W}} = {10}^{( \frac{{P}_{{REC}_{dBm} - 30}}{10} )} \\ = {10}^{( 2.02492 log ξ ( δ ) - 11.835081 ) .}\end{matrix} \qquad ( 4 \text{-} 30 )$$

Thus,

$$\begin{matrix}{V}_{REC} = \sqrt{{P}_{{REC}_{W}} R} \\ = \sqrt{376.73 * {10}^{( 2.02492 log ξ ( δ ) - 11.835081 )}} .\end{matrix} \qquad ( 4 \text{-} 31 )$$

Equation (31) is deterministic in the sense that it does not include the effects of the channel noise. It is helpful to determine the structure and coefficients of the function ξ in order to calculate VREC. Once VREC is calculated, it is filtered to produce an estimate of the received signal, VREC(t), which is then converted to received power and used in conjunction with Equation (4-3) to determine d.

It is possible to use a deterministic fourth-order state-space model for Rayleigh fading channels that approximates small-scale fading due primarily to multipath. The relative velocity of the aircraft being tracked results in a spreading effect of the channel which is captured its Doppler power spectral density (DPSD). The approximate transfer function \tilde{S}(s)=H(s)H(−s) is

$$\tilde{S} ( s ) = \frac{{K}^{2}}{{s}^{4} + 2 {ω}_{n}^{2} ( 1 - 2 {ζ}^{2} ) {s}^{2} + {ω}_{n}^{4}} . \qquad ( 4 \text{-} 32 )$$

The real portion is

$$H ( s ) = \frac{K}{{s}^{2} + 2 {ζω}_{n} s + {ω}_{n}^{2}} \qquad ( 4 \text{-} 33 )$$

in which the three parameters, K,ζ, and ωn can be adjusted in such a manner as to cause the transfer function to conform to the measured characteristics of the channel.

FIG. 4-6 shows the approximation of a typical DPSD by H(s) above. The function ξ=(δ) is modeled as a sum of exponentials, as follows

$$ξ ( δ ) = {α}_{1} {δ}^{2} {e}^{{β}_{1} δ} + {α}_{2} δ {e}^{{β}_{2} δ} . \qquad ( 4 \text{-} 34 a )$$

The estimated received signal, V_{REC}, is obtained by directing the unfiltered output values δi from the RTL 2832U-based SDR to an adaptive Kalman filter. The adaptive Kalman filter is supplied initial values for the parameters K, and ωm in (4-33), from which the system matrix is calculated. The output matrix and covariance matrices are determined from a subsequent optimization process in which the model parameters in (4-34) are also determined.

The second-order stochastic differential equation represented by the real portion of the channel transfer function, H(s), is

d²x(t)+2ζωₕdx(t)+ωₙ²x(t)=Kq(t). (4-34b)

This can be transformed into the following state equations

Ėx=Fx+Q (4-35)

z=Hx+R (4-36)

where

$$E = [ \begin{matrix}1 & 0 \\ 0 & 1\end{matrix} ] , \\ \dot{x} = [ \begin{matrix}\dot{x} \\ \ddot{x}\end{matrix} ] , and \\ F = [ \begin{matrix}0 & 1 \\ - {ω}_{n}^{2} & - 2 ζ {ω}_{n}\end{matrix} ] . \qquad ( 4 \text{-} 37 )$$

where fc is the 1090 MHz carrier frequency, vSOURCE is the velocity of the aircraft relative to the receiver, and c is the speed of light.

The peak amplitude of the received electric field vector, E0, is related to (t) by

$$\frac{{E}_{0}^{2}}{2} = 〈 {V}_{REC} ( t ) 〉 . \qquad ( 4 \text{-} 38 )$$

It follows that

E₀={square root over (2(V_{REC}(t)))}. (4-39)

### Also,

$$\frac{{E}_{0}}{2} = Var \{ I ( t ) \} = Var ( Q ( t ) \} . \qquad ( 4 \text{-} 40 )$$

The Doppler power spectral density function can be calculated as

$$S ( f ) = \frac{{E}_{0}}{4 π {f}_{max}} \frac{1}{\sqrt{1 - {( \frac{f}{{f}_{max}} )}^{2}}} . \qquad ( 4 \text{-} 41 )$$

The parameters K, ζ, and ωn are then determined as

$$\begin{matrix}ζ = \sqrt{\frac{1}{2} ( 1 - \sqrt{1 - \frac{S ( 0 )}{S ( {f}_{max} )}} )} , & ( 4 \text{-} 42 ) \\ {ω}_{n} = \frac{2 π {f}_{max}}{\sqrt{1 - 2 {ζ}^{2}}} , \\ and & ( 4 \text{-} 43 ) \\ K = {ω}_{n}^{2} \sqrt{S ( 0 )} . & ( 4 \text{-} 44 )\end{matrix}$$

The SDR host device outputs a series of eight values of δ, the measured signal level. These are filtered using an adaptive Kalman filter. The filter prediction equations are

xᵤ=Fx (4-45)

Pᵤ=FPF^{T}+Q (4-46)

and the update equations are

K=(HPᵤH^{T}+R)⁻¹ (4-47)

x=xᵤ+(zᵢ−Hxᵤ) (4-48)

P=Pᵤ−PᵤH^{T}K^{T} (4-49)

The initial coefficients are determined by calculating fmax from (4-37) using the first two data values to determine the derivative. The initial value of fmax then determines F. Q is set as

$$Q = [ \begin{matrix}Var ( x ) & 0 \\ 0 & Var ( \dot{x} )\end{matrix} ] \qquad ( 4 \text{-} 50 )$$

and H=[1 0] and R=0.5. The coefficients of the second row of the F matrix are then adjusted dynamically, based on updated values of E0 and fmax. Intuitively, this serves to adjust the degree of channel spreading due to variations in aircraft velocity,

The final value of the output of the Kalman filter is then used as the input to Equation (4-34), which is subsequently used in conjunction with Equations (4-30) and (4-3) to produce a distance estimate, [symbol] .

With Kalman filtering the process and observation noise covariance matrices are often unknown. The distance estimate [symbol] can be utilized with the Mode-S ES data, which provides exact position information for the signal source from which accurate distances can be calculated, to optimize the coefficients of both the process error function, ξ=f(δ), the covariance matrices Q and R, and the output matrix H. This is done with a multiparameter optimization function in R. The result is an adaptive filtering process that can be optimized over large data sets to yield the desired levels of accuracy of [symbol] . The filter can be tuned in an optimal manner based on existing environmental and positioning conditions, and can occur in a dynamic manner such that the roughly 25% of aircraft broadcasting Mode S ES with position information can influence the filter parameters for the 75% of aircraft broadcasting either Mode C or Mode S short squit signals.

The estimation algorithm was coded in R. The dataset to be used was collected over a single day in August of 2015 at the Lafayette, Indiana airport (KLAF). Purdue University operates a large flight training program at that airport using a fleet of Cirrus SR20 aircraft equipped with Mode S transponders with extended squitter (ADS-B) output. Data transmissions were received by the SDR-host combination and recorded in comma-separated variable format. The data file was subsequently processed by adding a distance field, with actual distances determined by a separate R script, and filtered to exclude all distances greater than 5 nm (9.26 km). The resulting file consisted of 1588 records from multiple aircraft at various times throughout the day.

The file was processed and an optimization process using the algorithm of Nelder and Mead run over the entire dataset, The metric used to determine the error between actual and estimated distances was the sum of the absolute error

$${e}_{total} = {\sum }_{i = 1}^{N} \vert {d}_{i} - {\hat{d}}_{1} \vert \qquad ( 4 \text{-} 51 )$$

The value of etotal calculated for the dataset was 267.65 km on 250 records and 2448.4 km on 1588 records. This equates to 1.07 km/record on 250 records and 1.538 km/record on 1588 records, or 0.54 nm/record (10.8%) and 0.83 nm/record (16.6%), respectively. A histogram indicating absolute error in km is shown in g. 10 7.

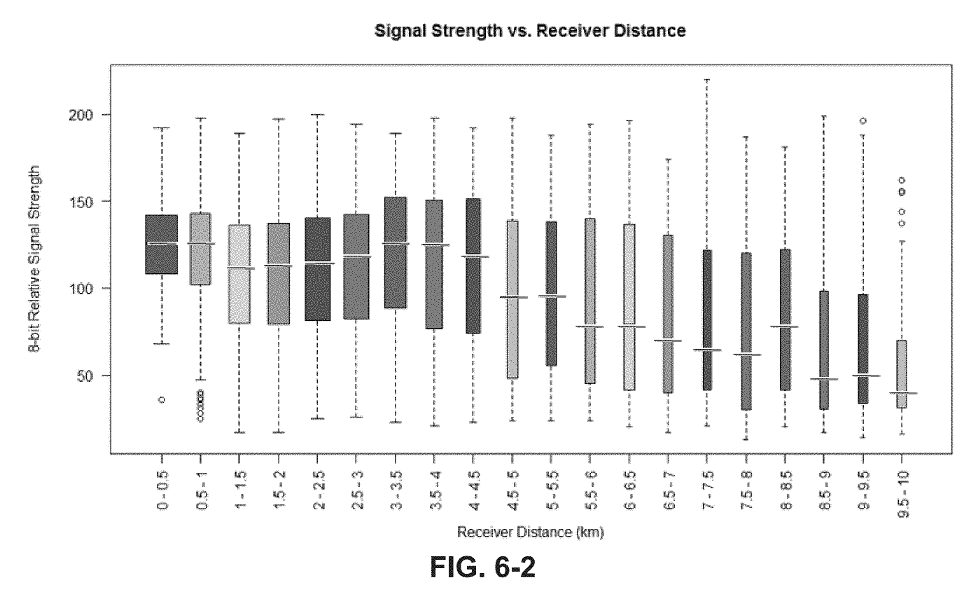

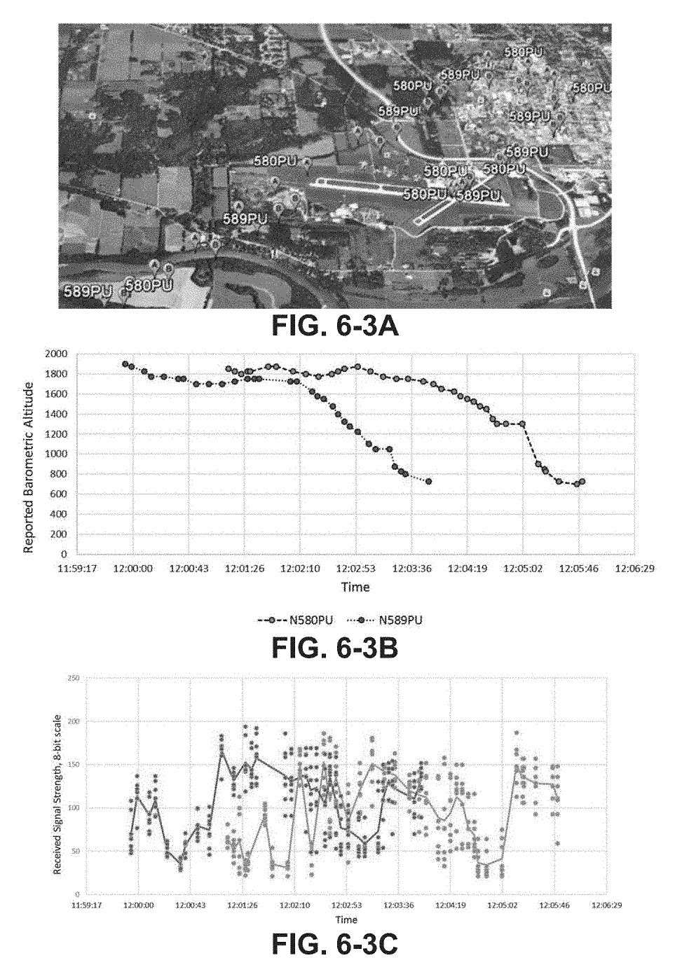

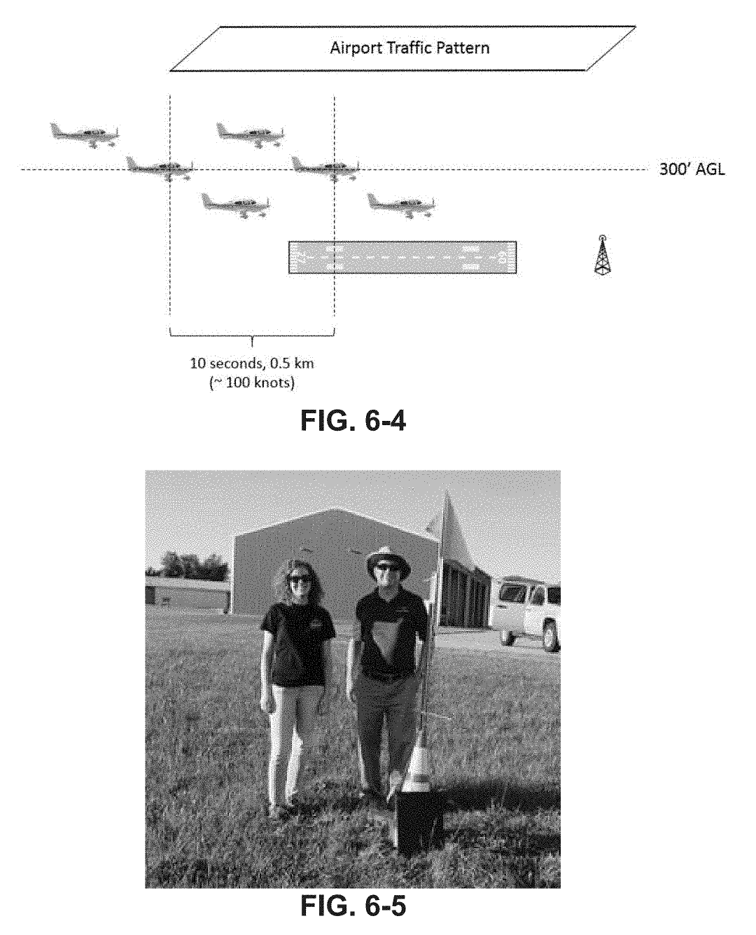

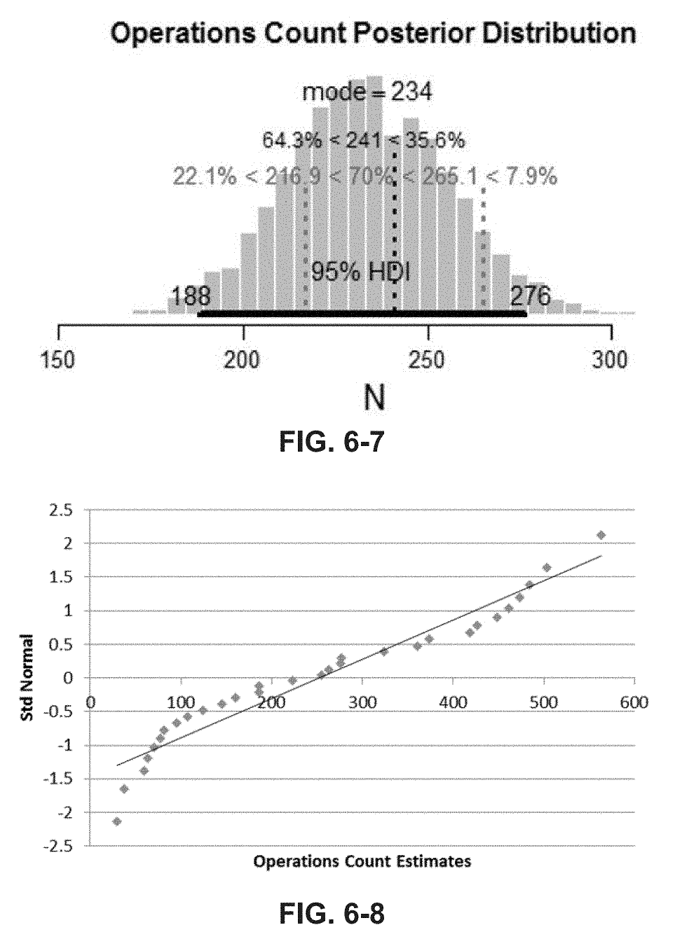

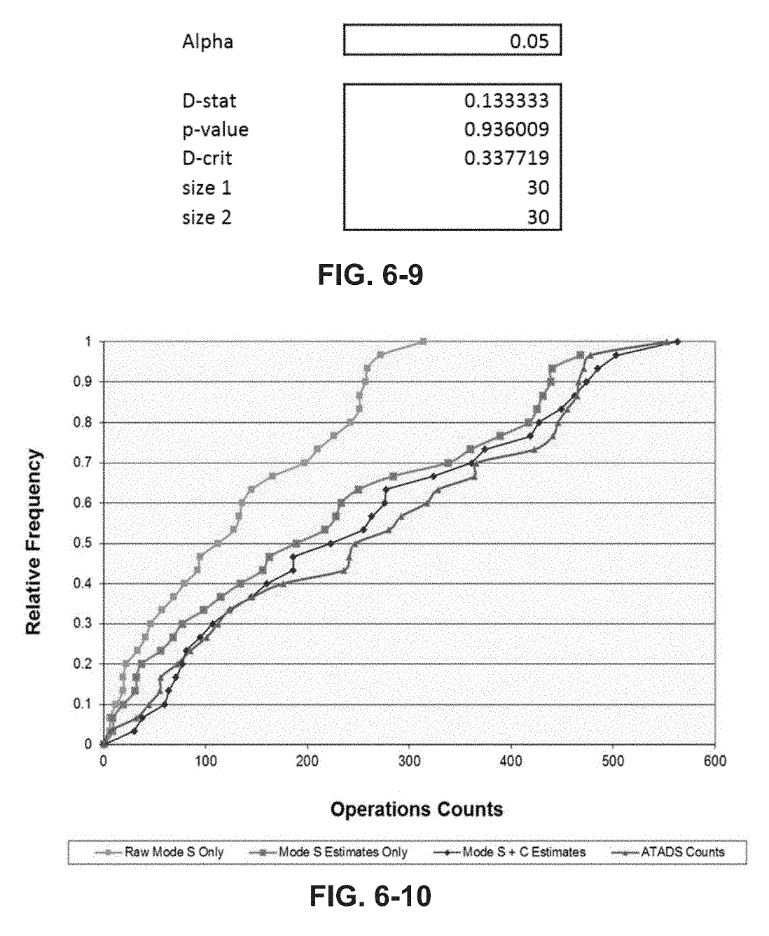

One embodiment of the present invention employs the use of the signal amplitude and barometric altitude parameters available in the Mode S short squitter and Mode C data streams to determine the proximity of an aircraft relative to the receiver, a process which poses some significant challenges, The received signal is subject to scattering effects from atmospheric phenomena such as clouds and precipitation, multipath interference, variation in received frequency due to Doppler effects related to aircraft velocity, and receiver noise (FIG. 6-2). The noise inherent in the signal precludes the use of a simple binary signal strength threshold for counting aircraft operations.

A clearer illustration of the challenges associated with using Mode S SS and Mode C signals to complement the use of Mode S ES signals, with their attendant position information, is provided in FIGS. 6-3. In FIG. 6-3A, the flight paths of two general aviation training aircraft, N589PU (aircraft A) and N580PU (aircraft B), inbound to the Purdue University airport, are shown, along with (FIG. 6-3B) their altitudes and (FIG. 6-3C) plotted transponder signal strength as a function of time, Deviations in the received signal level can be seen to vary with linear distance, altitude, and obstructions interfering with line-of-sight signal reception.

The accuracy of the estimation of aircraft proximity can be improved through the use of a self-tuning Kalman filter based on known Mode S ES aircraft locations; the concept here being that the variation due to scattering, velocity, and receiver noise can be determined given known aircraft position data, and those estimates used to tune the filter parameters such that the distances of the aircraft not transmitting position information can be better estimated. In addition, barometric altitude as reported in the aircraft data stream can be corrected for local fluctuations in atmospheric pressure. The researchers developed a technique to use the Mode S short squit and Mode C signals in the counting technology. Mode C operations are estimated by assuming that two successive transmissions from aircraft passing through a horizontal plane 300 feet above airport elevation that are within 10 seconds of one another and with distance estimates of within 0.5 km of each other are a single unique aircraft engaged in an operation (FIG. 6-4), Transmissions from aircraft in the 300′ plane above the airport that exceed either 0.5 km in estimated distance from the receiver or 10 seconds in time are considered to be coming from different aircraft.

In one embodiment there is a method for estimating operations counts that employs a relative frequency model based on sampling without replacement from a discrete, finite, uniformly-distributed population. This method can be shown to improve estimates of the count parameter for small sample sizes (n<50), Yet other embodiments contemplate a method of estimating operations counts based on the output of the transponder data collection device. This method involves a Markov Chain Monte Carlo (MCMC) simulation and associated Bayesian hierarchical model using a Poisson likelihood function, which incorporates the inherent Poisson nature of the underlying arrival process and assumes uncertainties in the registration of operations counts. The latter approach is shown to improve the accuracy of both the traditional, unmodified predictor and the relative frequency-based modification.

The transponder data collection device can be easily field-deployed at a small general aviation airport to collect the data needed to accurately establish airport operations counts (FIG. 6-5), If a 110 VAC power connection is unavailable, it can be powered with a combination of a solar panel and battery. The device can be connected directly to a network for data transmission; however, lack of network connectivity can be resolved by recording the data on a memory card and periodically retrieving it for upload to a server.

The development of this inexpensive, easily-deployed device for recording operations counts at general aviation airports suggests a need for validating the accuracy of the resulting data, One means of doing so is to conduct a study of the resulting counts at a towered airport by comparing them to official count data extracted from the FAA ATADS database.

A fixed installation of the transponder data collection device, powered by alternating current and connected to the Internet, was deployed, The positioning of the unit was done in such a way that the receiving antenna has maximum exposure to the runway complex at the Lafayette, Indiana airport, on which the facility is located.

The estimated counts obtained from the processing according to one embodiment of the present invention were compared with the count information obtained from control tower personnel and publicly-available in the FAA's Air Traffic Activity Data System (ATADS) database. This database contains the official National Airspace System air traffic operations data available for public release. Data for the previous month is made available on the ATADS website on the 20th of each month.

Data from the transponder receiver unit were collected over a 30-day period and subsequently processed and analyzed for comparison with the control tower operations counts, as obtained from the ATADS database, over the same period, The raw transponder data were retrieved in the form of a single large .csv file and analyzed by the signal processing algorithm to register raw operations counts, and further processed by the Bayesian estimation software to estimate the final daily operation counts. Both the signal processing algorithm and the Bayesian estimation model were coded in R. Because the Bayesian algorithm returns a complete posterior pmf based on the input data vector, a modal value can be easily determined and serves as an appropriate estimator for the daily operations count. An example posterior distribution for showing the 95% highest density interval (HDI) and the ATADS count for that day (241 operations) is provided in FIG. 6-7. A 10% range of practical equivalence (ROPE) on either side of the ATADS count value is shown so that the degree to which the estimated distribution falls within that region may be easily discerned.

The data vector consisting of the modal estimates from each day of operations over the 30-day period under consideration was first examined for normality. A Shapiro-Wilk test resulted in a value of 0.9329 for W, the test statistic, corresponding to a p-value of 0.0340. Assuming a value of α=0.05, the null hypothesis of normality should be rejected; this was confirmed by visual inspection of a Q-Q plot (FIG. 6-8). Hence, a nonparametric comparison of the modal estimates with the ATADS data is appropriate.

Over the 30-day period, the total count estimate was 7,559, compared with an ATADS total of 7.837, a difference of 4.03%. A discretized two-sample Kolmogorov-Smirnov test was utilized to compare the empirical cumulative distribution functions of the estimated counts and the ATADS data over the 30-day period (FIG. 6-9). The resulting test statistic D was 0.1333, with a critical value of 0.3377 and a corresponding p-value of 0.9360. This implies that the empirical CDFs are not dissimilar to the extent that they represent different populations, suggesting that the operations count estimates are of sufficient accuracy.

An Anderson-Darling test was also conducted, as it can be viewed as preferred over the Kolmogorov-Smirnov test due to the latter test's lesser power and lack of sensitivity at the tails of the distributions being compared. The results of the test were similar to those of the Kolmogorov-Smirnov test; the null hypothesis that the empirical cumulative distribution functions of the estimates and the ATADS counts are equivalent could not be rejected (p=0.981).

In addition, it is useful to compare visually the empirical cumulative distribution functions for several different types of counts with the actual ATADS-based counts to gain a better understanding for the value added by the distance estimation and statistical count estimation processes. Three types of cumulative distributions were calculated for this comparison:
1. The 30-day distribution based on raw counts of operations (obtained without the estimation portion of the algorithm) using only Mode S (both short- and extended-squit) data with GPS positions and barometric altitudes, when available.
2. The 30-day distribution based on statistical estimates using only Mode S data with available GPS positions and barometric altitudes.
3. The 30-day distribution based on statistical estimates using both Mode S data and Mode C data.

These three distributions were plotted along with a distribution based solely on the actual ATADS count data. All four distributions are depicted in FIG. 6-10. It is evident from this composite distribution plot that the distribution most closely approaching the actual count distribution is that of the statistical filtering and estimation procedure using Mode S and Mode C data under study, The second closest distribution is that using the filtering and estimation procedure with only Mode S data, It should be noted that, while neither of these distributions of estimated counts exceeds the range of statistical significance prescribed by the Kolmogorov-Smirnov test, and may therefore be considered equivalent to the actual ATADS distribution, the former is, from the plot, clearly closer in measure to the actual distribution. It should also be noted that the distribution of raw Mode S data does exceed the range of statistical significance and may therefore not be considered equivalent. Note, in addition, by the Glivenko-Cantelli Theorem, that distributions that are Kolmogorov-Smirnov equivalent converge almost surely over an infinite number of samples.

The current state of the practice in operations count determination involves the use of acoustic counters that have an accuracy of around 15%, require labor-intensive calibration and output analysis, and have a high degree of susceptibility to noise from mowing equipment and wind. The approach presented here uses much lower-cost equipment to collect transponder data. Provided that a small percentage of nearby aircraft broadcast Mode S ES signals, the processing algorithm self-calibrates to effectively determine operations counts using both Mode C and Mode S data. A month-long deployment of this system at an airport with 7,837 actual operations composed of approximately 18% Mode C and 72% Mode S (both SS and ES) signals produced monthly operations counts that were within 5% of the ATADS counts (FIG. 6-10).

Various aspects of different embodiments of the present invention are expressed in paragraphs X1 or X2 as follows:

X1. One aspect of the present invention pertains to a method for estimating the operation of an aircraft. The method preferably includes receiving first radio data from a transponder of a first flying aircraft, and determining from the data the likelihood of the first aircraft landing at the airport. In yet other embodiments, the method preferably includes determining from radio data of a parked airplane the likelihood of the parked airplane departing from the airport. The method preferably includes automatically logging that the first aircraft has landed at the airport based on said determining.

X2. Another aspect of the present invention pertains to a method for estimating the operation of an aircraft. The method preferably includes providing an antenna at an airport having an input adapted and configured for receiving a radio signal and an output in electrical communication with a computer. The method preferably includes receiving a Mode S extended-squitter (ES) radio signal by the antenna from a first aircraft, and determining the overall signal strength of the radio signal from the first aircraft by the computer. The method preferably includes receiving a radio signal from a second aircraft. The method preferably includes using the overall signal strength of the first radio signal and estimating the strength of the second radio signal. The method preferably includes determining from the estimated second radio signal the distance from the antenna to the second aircraft.

Yet other embodiments pertain to any of the previous statements X1 or X2, which are combined with one or more of the following other aspects. It is also understood that any of the aforementioned X paragraphs include listings of individual features that can be combined with individual features of other X paragraphs.

Wherein the first radio data includes the pressure altitude of the first aircraft and said determining includes correcting the pressure altitude by the barometric pressure of the airport.

Wherein the first radio data is a time sequence of data and said determining includes calculating the glide slope of the first aircraft.

Wherein the radio data does not include the altitude of the aircraft.

Which further comprises receiving second radio data from the transponder of a second flying aircraft, and said determining includes correcting the first radio data with the second radio data

Wherein the second data is from one of a Mode S ES or UAT transponder.

Wherein said correcting includes calculating the fading of the second radio signal.

Wherein said correcting includes calculating the Doppler shift of the second radio signal.

Which further comprises estimating the altitude of the first aircraft during said determining.

Wherein the memory includes a model of the airspace above the airport and said determining includes comparing the estimated altitude of the first aircraft to the model.

Which further comprises preventing another said logging of the first aircraft after said logging unless said comparing indicates that the first aircraft has left the airspace.

Which further comprises estimating the glide slope of the first aircraft during said determining.

Which further comprises preventing said logging unless the estimated glide slope is negative.

Which further comprises estimating the heading of the first aircraft during said determining.

Wherein the memory includes a model of the geometric orientation of a runway of the airport and said determining includes comparing the estimated heading of the first aircraft to the orientation of the runway.

Wherein said logging includes at least one of the ICAO ID or the tail number of the first aircraft.

Wherein the transponder is one of a Mode C or Mode S short-squitter (SS) transponder.

Wherein said receiving is a plurality of Mode S ES radio signals and each of the plurality of Mode S ES signals includes a corresponding pair of individual signal strength and individual distance.

Which further comprises applying a Kalman filter to the plurality of Mode S ES signals.

Wherein said applying a Kalman filter includes adapting the Kalman filter with the plurality of distances.

Wherein said applying a Kalman filter includes adapting the Kalman filter to account for Doppler shift in the plurality of Mode S ES signals.

Wherein said applying a Kalman filter includes adapting the Kalman filter to account for transmission noise in the plurality of Mode S ES signals.

Wherein said determining the overall signal strength includes estimating the fading of the Mode S ES signal.

Wherein said estimating is with a Rayleigh model or a Rician model.

Wherein said determining is with the Friis transmission equation.

Those skilled in the art will recognize that numerous modifications can be made to the specific implementations described above. The implementations should not be limited to the particular limitations described. Other implementations may be possible.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method for estimating the operation of an aircraft at an airport, comprising:
providing at an airport an antenna having an input adapted and configured for receiving a radio signal and an output in electrical communication with a computer having memory;
receiving first radio data from a transponder of a first flying aircraft;
determining from the first data the likelihood of the first aircraft landing at the airport; and
automatically logging by the computer in memory that the first aircraft has landed at the airport based on said determining.

2. The method of claim 1 wherein the first radio data includes the pressure altitude of the first aircraft and said determining includes correcting the pressure altitude by the barometric pressure of the airport.

3. The method of claim 2 wherein the first radio data is a time sequence of data and said determining includes calculating the glide slope of the first aircraft.

4. The method of claim 1 wherein the radio data does not include the altitude of the aircraft.

5. The method of claim 1 which further comprises receiving second radio data from the transponder of a second flying aircraft, and said determining includes correcting the first radio data with the second radio data.

6. The method of claim 5 wherein the second data is from one of a Mode S ES or UAT transponder.

7. The method of claim 5 wherein said correcting includes calculating the fading of the second radio signal.

8. The method of claim 5 wherein said correcting includes calculating the Doppler shift of the second radio signal.

9. The method of claim 1 which further comprises estimating the altitude of the first aircraft during said determining.

10. The method of claim 9 wherein the memory includes a model of the airspace above the airport and said determining includes comparing the estimated altitude of the first aircraft to the model.

11. The method of claim 10 which further comprises preventing another said logging of the first aircraft after said logging unless said comparing indicates that the first aircraft has left the airspace.

12. The method of claim 1 which further comprises estimating the glide slope of the first aircraft during said determining.

13. The method of claim 12 wherein said determining uses the estimated glide slope.

14. The method of claim 1 which further comprises estimating the heading of the first aircraft during said determining.

15. The method of claim 14 wherein the memory includes a model of the geometric orientation of a runway of the airport and said determining includes comparing the estimated heading of the first aircraft to the orientation of the runway.

16. The method of claim 1 wherein said logging includes at least one of the ICAO ID or the tail number of the first aircraft.

17. The method of claim 1 wherein the transponder is one of a Mode C or Mode S short-squitter (SS) transponder.

18. The method of claim 1 wherein the computer is a software defined radio (SDR) including a receiver that receives the radio signal and provides a corresponding analog signal to said SDR.

19. The method of claim 1 wherein the transponder is a Mode C transponder.

20. The method of claim 1 wherein the transponder is a Mode S short-squitter (SS) transponder.

21. A method for estimating the operation of an aircraft at an airport, comprising:
providing an antenna at an airport having an input adapted and configured for receiving a radio signal and an output in electrical communication with a computer;
receiving a Mode S extended-squitter (ES) radio signal by the antenna from a first aircraft;
determining the overall signal strength of the radio signal from the first aircraft by the computer;
receiving one of a Mode C or Mode S short-squitter (SS) radio signal from a second aircraft;
using the overall signal strength of the first radio signal and estimating the strength of the second radio signal; and
determining from the estimated second radio signal the distance from the antenna to the second aircraft.

22. The method of claim 21 wherein said receiving is a plurality of Mode S ES radio signals and each of the plurality of Mode S ES signals includes a corresponding pair of individual signal strength and individual distance.

23. The method of claim 22 which further comprises applying a Kalman filter to the plurality of Mode S ES signals.

24. The method of claim 23 wherein said applying a Kalman filter includes adapting the Kalman filter with the plurality of distances.

25. The method of claim 23 wherein said applying a Kalman filter includes adapting the Kalman filter to account for Doppler shift in the plurality of Mode S ES signals.

26. The method of claim 23 wherein said applying a Kalman filter includes adapting the Kalman filter to account for transmission noise in the plurality of Mode S ES signals.

27. The method of claim 21 wherein said determining the overall signal strength includes estimating the fading of the Mode S ES signal.

28. The method of claim 27 wherein said estimating is with a Rayleigh model.

29. The method of claim 27 wherein said estimating is with a Rician model.

30. The method of claim 21 wherein said determining is with the Friis transmission equation.

31. The method of claim 21 which further comprises receiving by computer the ambient barometric pressure at the airport and correcting the pressure altitude data from the second radio signal to the above ground level (AGL) altitude of the second aircraft.

32. The method of claim 21 wherein said receiving is a Mode C signal.

33. The method of claim 21 wherein said receiving is a Mode S SS signal.

34. A system for estimating the operation of an aircraft at an airport, comprising:
a software defined radio (SDR);
a barometric pressure transducer providing a pressure signal corresponding to atmospheric pressure proximate to said SDR
an antenna adapted and configured to receive one of a first Mode C or Mode S SS radio signal from the transponder of a first aircraft at about 1090 MHz;
wherein said antenna provides the radio signal to said SDR, and said SDR interprets the operational altitude of the first aircraft from the first radio signal and corrects the operational altitude to a first above ground level (AGL) altitude using the pressure signal; and
wherein said SDR increments an airport operations counter if the first AGL altitude is below a predetermined threshold.

35. The system of claim 34 wherein said antenna receives a second Mode S ES radio signal from a second aircraft, said SDR receives the second radio signal, interprets the operational altitude of the second aircraft, and computes the relative signal strength (RSS) of the first radio signal relative to the second radio signal.

36. The system of claim 34 wherein said SDR computes a distance of the first aircraft using the RSS, and said SDR increments the airport operations counter if the computed distance is below a predetermined threshold.

37. The system of claim 34 wherein the RSS is a first RSS, and the SDR computes a second RSS of a second signal from the first aircraft relative to a signal of the second aircraft, and said SDR increments the airport operations counter if the second RSS is greater than the first RSS.

38. The system of claim 34 wherein said SDR includes memory and the memory includes an adaptive software filter for correcting the signal strength for Doppler effect.

39. The system of claim 34 which further comprises means for outputting the counter data to a user.

40. The method of claim 1 which further comprises:
receiving second radio data from a transponder of a second aircraft parked at the airport;
determining from the second radio data the likelihood of the second aircraft departing from the airport; and
automatically logging by the computer in memory that the second aircraft has departed from the airport based on said determining from the second data.

41. The method of claim 21 wherein the computer is a software defined radio (SDR) including a receiver that receives the radio signal and provides a corresponding analog signal to said SDR.

42. The method of claim 23 wherein said computer includes a receiver that receives the second radio signal, wherein said applying a Kalman filter includes adapting the Kalman filter to account for receiver noise.
